(19) United States
(12) Patent Application Publication
(10) Pub. No.: US 2014/0142250 A1
(43) Pub. Date: May 22, 2014

(54) SUPRAMOLECULAR STRUCTURE HAVING SUB-NANO SCALE ORDERING

(71) Applicant: Gwangju Institute of Science And Technology, Gwangju-city (KR)

(72) Inventors: Jae-Suk Lee, Gwangju-city (KR); Changej Mohammad, Gwangju-city (KR); Haeng-Deog Koh, Gwangju-city (KR); Samal Shashadhar, Gwangju-city (KR); Nam-Goo Kang, Gwangju-city (KR); Won-Jung Shin, Gwangju-city (KR); Young-Jae Kim, Gwangju-city (KR); Hong-Joon Lee, Gwangju-city (KR); Walaa Elsawy, Gwangju-city (KR)

(73) Assignee: Gwangju Institute of Science And Technology, Gwangju-city (KR)

(21) Appl. No.: 14/095,332

(22) Filed: Dec. 3, 2013

Related U.S. Application Data
(63) Continuation-in-part of application No. 12/992,534, filed on Feb. 7, 2011, now abandoned.

(51) Int. Cl. C08F 299/00; C08F 228/06; C08F 226/02; C08G 81/02; C08F 226/06

(52) U.S. Cl. CPC C08F 299/00; C08G 81/024; C08F 226/06; C08F 226/02; C08F 228/06
USPC 525/123; 525/280; 525/327.1; 525/540; 525/326.7; 525/327.2

(57) ABSTRACT

An organic crystalline composition is provided. The organic crystalline composition includes a main material having π-conjugated back bone and a functional group containing an atom having an unshared electron pair, and a linking material combining with the adjacent main material at the functional group by quaternization, organic material-metal interaction, ionic bonding, or hydrogen bonding.

### RELATED APPLICATIONS

The present application is a continuation in part of U.S. patent application Ser. No. 12/992,534 filed Feb. 7, 2011, which is U.S. national stage application under 35 U.S.C. §371 of International No: PCT/KR2008/002718 filed May 15, 2008, each of which is incorporated herein by reference in its entirety.

### TECHNICAL FIELD

The present invention relates to a nano-crystalline structure of an organic material and a method of forming the structure, and more particularly, to a nano-crystalline structure formed by quaternization, hydrogen bonding, ionic bonding, or metal coordination between a main material composed of a block copolymer, a homopolymer or a monomer, and a linking material, to obtain electrical characteristics.

### BACKGROUND

Research has been conducted into pattern structures on the scale of micrometers down to tens of nanometers, and their crystallization based on phase separation or self-assembly of a block copolymer. For this research, a block copolymer having an amphiphilic (hydrophilic and hydrophobic) group or a polymer having crystallinity has been used as a raw material.

Recent developments in the preparation of a crystalline polymer have focused on an interaction between a main material and a linking material, but little progress has been made toward controlling a crystalline structure.

### DISCLOSURE

### Technical Problem

The present invention is directed to an organic crystalline structure capable of being used as an organic semiconductor device.

### Technical Solution

One aspect of the present invention provides an organic crystalline structure including a main material having π-conjugated back bone and a functional group containing an atom having an unshared electron pair, and a linking material combining with the adjacent main material at the functional group by quaternization, organic material-metal interaction, ionic bonding, or hydrogen bonding.

### Advantageous Effects

According to the present invention, a linking material is introduced into a main material such as various types of polymers or monomers by quaternization, hydrogen bonding, ionic bonding, or organic material-metal interaction. By an interaction between the main material and the linking material, a uniform crystalline structure of several nanometers in size can be obtained. Further, when this structure is embodied as a device, the device exhibits ideal diode characteristics. That is, this structure can be employed in organic electrical devices, for example, devices formed of organic semiconductor, and thus can be utilized as a variety of electronic materials.

### DESCRIPTION OF DRAWINGS

FIG. 1 shows a high-resolution transmission electron microscope (HR-TEM) image of a nano crystalline structure of a polymer micelle cross-linked with 1,4-dibromobutane in poly(2-vinylpyridine)-block-poly(hexylisocyanate) (P2VP-b-PHIC) according to a first exemplary embodiment of the present invention;

FIG. 2 shows (a) a Fast Fourier Transform (FFT) image and (b) a processed FFT image of the nano crystalline structure of the polymer micelle cross-linked with 1,4-dibromobutane in P2VP-b-PHIC according to the first exemplary embodiment of the present invention;

FIG. 3 shows an X-ray diffraction (XRD) result of the nano crystalline structure of the polymer micelle cross-linked with 1,4-dibromobutane in P2VP-b-PHIC according to the first exemplary embodiment of the present invention;

FIG. 4 shows TEM images of a nano crystalline structure of a polymer micelle quaternized with 1-bromobutane in P2VP-b-PHIC dispersed in a mixed solvent of methanol and toluene in a volume ratio of 8:2 according to the first exemplary embodiment of the present invention, ((a) scale bar: 500 nm, (b) scale bar: 10 nm, (c) enlarged image of (b));

FIG. 5 shows a density distribution of fringe spacings of the nano crystalline structure of the polymer micelle quaternized with 1-bromobutane in P2VP-b-PHIC dispersed in a mixed solution of methanol and toluene in a volume ratio of 8:2 according to the first exemplary embodiment of the present invention;

FIG. 6 shows TEM images of a polymer film quaternized with 1,4-dibromobutane in P2VP-b-PHIC dispersed in a THF solvent in a concentration of 0.1 to 1 mg/ml, wherein (a) is an energy-filtering TEM (EF-TEM) image and an XRD result, and (b) is an HR-TEM image and a density distribution of fringe spacings of a polymer nano crystalline structure;

FIG. 7 shows an XRD result of the polymer film quaternized with 1,4-dibromobutane in P2VP-b-PHIC dispersed in a THF solvent in a concentration of 0.1 to 1 mg/ml;

FIG. 8 shows (a) an HR-TEM image, (b) a high-powered HR-TEM image, and (c) a density distribution of fringe spacings of a nano crystalline structure of a polymer micelle cross-linked with 75 mole % of 1,4-dibromobutane, based on the mole of a vinyl pyridine unit of the P2VP-b-PHIC, in P2VP-b-PHIC;

FIG. 9 shows (a) an HR-TEM image, (b) a high-powered HR-TEM image, and (c) a density distribution of fringe spacings of a nano crystalline structure of a polymer micelle cross-linked with 50 mole % of 1,4-dibromobutane, based on the mole of a vinyl pyridine unit of the P2VP-b-PHIC, in P2VP-b-PHIC;

FIG. 10 shows (a) an HR-TEM image, and (b) a high-powered HR-TEM image of a nano crystalline structure of a polymer micelle cross-linked with 1,4-dibromobutane in poly(2-vinylpyridine)-block-polystyrene (P2VP-b-PS) dispersed in a mixed solution of methanol and THF in a volume ratio of 8:2 according to the first exemplary embodiment of the present invention;

FIG. 11 shows a density distribution of fringe spacings of the nano crystalline structure of the polymer micelle cross-linked with 1,4-dibromobutane in P2VP-b-PS dispersed in a mixed solution of methanol and THF in a volume ratio of 8:2 according to the first exemplary embodiment of the present invention;

FIG. 12 shows (a) an HR-TEM image, and (b) a high-powered HR-TEM image of a nano crystalline structure of a polymer micelle cross-linked with 1,4-dibromobutane in P2VP-b-PS dispersed in a mixed solution of toluene and methanol in a volume ratio of 8:2 according to the first exemplary embodiment of the present invention;

FIG. 13 shows a density distribution of fringe spacings of the nano crystalline structure of the polymer micelle cross-linked with 1,4-dibromobutane in P2VP-b-PS dispersed in a mixed solution of toluene and methanol in a volume ratio of 8:2 according to the first exemplary embodiment of the present invention;

FIG. 14 shows an XRD result of the nano crystalline structure of the polymer micelle cross-linked with 1,4-dibromobutane in P2VP-b-PS dispersed in a mixed solution of toluene and methanol in a volume ratio of 8:2 according to the first exemplary embodiment of the present invention;

FIG. 15 shows an AFM image of a polymer film cross-linked with 1,4-dibromobutane in a poly(vinylphenylpyridine)-block-poly(2-vinylpyridine) (PP2VP-b-P2VP) block copolymer dispersed in a THF solvent according to the first exemplary embodiment of the present invention;

FIG. 16 shows an HR-TEM image and a diffraction result of the polymer film cross-linked with 1,4-dibromobutane in a poly(vinylphenylpyridine)-block-poly(2-vinylpyridine) (PP2VP-b-P2VP) block copolymer dispersed in a THF solvent according to the first exemplary embodiment of the present invention;

FIG. 17 shows an HR-TEM image and a diffraction image of a nano crystalline structure of a monomer film in which poly(2-vinylpyridine) dispersed in a methanol solvent is cross-linked with hydroquinone by hydrogen bonding according to a second exemplary embodiment of the present invention;

FIG. 18 shows an FFT image of the HR-TEM image and a density distribution of fringe spacings of the nano crystalline structure of the monomer film in which poly(2-vinylpyridine) dispersed in a methanol solvent is cross-linked with hydroquinone by hydrogen bonding according to the second exemplary embodiment of the present invention;

FIG. 19 shows an HR-TEM image of a nano crystalline structure of a monomer film cross-linked with 1,4-dibromobutane in 2,2-bipyridine dispersed in a dimethylformamide (DMF) solvent according to the second exemplary embodiment of the present invention;

FIG. 20 shows an FFT image of the HR-TEM image and an enlarged result of the nano crystalline structure of the monomer film cross-linked with 1,4-dibromobutane in 2,2-bipyridine dispersed in a dimethylformamide (DMF) solvent according to the second exemplary embodiment of the present invention;

FIG. 21 shows an EF-TEM image of a rod-shaped polymer film in which polyaniline is cross-linked with chlorozinc (ZnCl₂) by metal-polymer coordination according to a third exemplary embodiment of the present invention;

FIG. 22 shows an FFT image of an HR-TEM image of the rod-shaped polymer film in which polyaniline is cross-linked with ZnCl₂ by metal-polymer coordination according to a third exemplary embodiment of the present invention;

FIG. 23 shows a technique of measuring electrical characteristics of a polymer film having an organic crystalline structure formed according to the present invention; and

FIG. 24 is a graph of electrical characteristics of an organic single crystalline polymer according to a fourth exemplary embodiment of the present invention.

FIG. 25 shows a HR-TEM image and a Fourier transformed image of the film having cross-linked polyaniline and diiodobutane by quaternization.

FIG. 26 shows an XRD result of the film having cross-linked polyaniline and diiodobutane by quaternization (PANI-DIB-100) and non cross-linked polyaniline (PANI-EB).

FIG. 27 shows a HR-TEM image and a Fourier transformed image of the film having crystallized polypyrrole and ZnCl₂ by organic material-metal interaction.

FIG. 28 shows an XRD result of the film having crystallized polypyrrole and ZnCl2 by organic material-metal interaction.

FIG. 29 shows a HR-TEM image of the film having cross-linked PEDOT and DSA by protonation and ionic bonding.

FIG. 30 shows an XRD result of the film having cross-linked PEDOT and DSA by protonation and ionic bonding.

FIG. 31 shows a HR-TEM image and a Fourier transformed image of the film having cross-linked thiophene-isoindigo-thiophene and EDA by hydrogen bonding.

### MODE FOR INVENTION

As used herein, “substitution” may mean at least one hydrogen in a specific functional group is substituted into a heavy hydrogen, a halogen group, a hydroxy group, an amino group, a cyano group, an amine group, a nitro group, a C1 to C30 alkylsilyl group, a C3 to C30 cycloalkyl group, a C5 to C30 aryl group, a C2 to C30 heteroaryl group, a C1 to C20 alkoxy group, or a C1 to C10 trifluoroalkyl group unless the context clearly indicates otherwise. Adjacent two substituted groups may combine to make a saturated or unsaturated or aromatic ring.

As used herein, an “alkyl group” may mean an aliphatic hydrocarbon group unless the context clearly indicates otherwise. The alkyl group may be a saturated alkyl group without any bouble bond or triple bond, or an unsaturated alkyl group with any bouble bond or triple bond. The saturated or unsaturated alkyl group may be a branched, a linear, or a cyclo alkyl group. The alkyl group may be a C1 to C30, specifically a C1 to C10 or a C1 to C6 alkyl group. For example, C1 to C4 alkyl group may be a methyl, an ethyl, a propyl, an iso-propyl, an n-butyl, an iso-butyl, a sec-butyl, or a t-butyl group. As used herein, an “aryl group” may mean a monocyclic aromatic group or a polycyclic aromatic group including fused aromatic rings, and may include a heteroaryl group unless the context clearly indicates otherwise.

As used herein, a “heteroaryl group” may mean a monocyclic aromatic group or polycyclic aromatic group having fused aromatic rings, and includes at least one of nitrogen, phosphorus, oxygen, sulfur, and selenium in at least one ring as a ring member and carbon(s) as the other ring member(s) unless the context clearly indicates otherwise. As used herein, the terms “structure” and “composition” are used interchangeably. Non-limiting examples of a structure or composition include a compound, polymer, salt, film or micelle.

As used herein, a “polymer” may include an oligomer unless the context clearly indicates otherwise.

Hereinafter, exemplary embodiments of the present invention will be described in detail with reference to the accompanying drawings.

In the exemplary embodiments of the present invention, an organic crystalline structure includes a main material and a linking material. The main material may include a functional group containing at least one atom having an unshared electron pair. The atom having an unshared electron pair may be selected from the group consisting of nitrogen(N), phosphorus(P), oxygen(O), sulfur(S), and selenium(Se). The functional group containing the atom having an unshared electron pair may be amines, anilines, indolinones, carbazoles, pyridines, pyrroles and thiophenes.

The main material may be at least one of the compositions of the following Formulae 1 to 16.

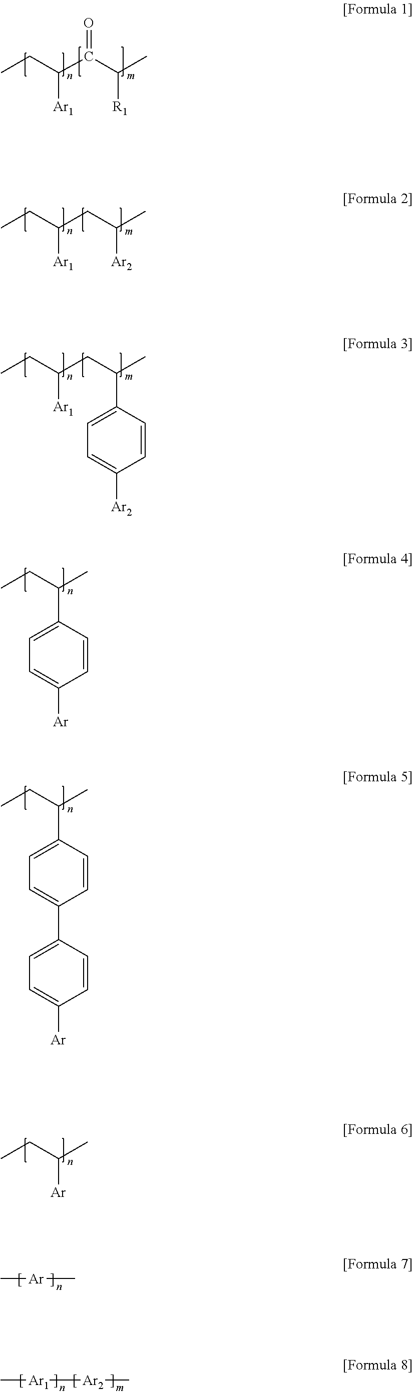

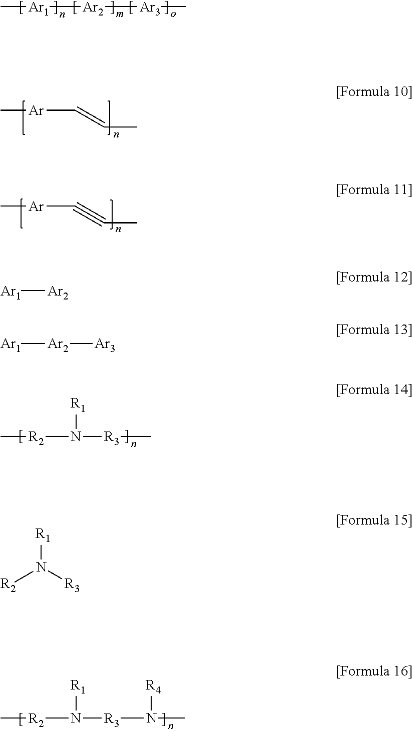

In each of Formulae 1, 4-7, 10, and 11, Ar may be a substituted or unsubstituted C2 to C30 aryl group including at least one atom having an unshared electron pair. In each of Formulae 2, 3, 8, and 12, at least one of Ar₁ and Ar₂ may be a substituted or unsubstituted C2 to C30 aryl group having an unshared electron pair, and the other, if any, of Ar₁ and Ar₂ may be a substituted or unsubstituted C2 to C30 aryl group. In each of Formulae 9 and 13, at least one of Ar₁, Ar₂, and Ar₃ may be a substituted or unsubstituted C2 to C30 aryl group having an unshared electron pair, and the other(s), if any, of Ar₁, Ar₂, and Ar₃ may be a substituted or unsubstituted C2 to C30 aryl group. The atom having an unshared electron pair may be selected from the group consisting of nitrogen, phosphorus, oxygen, sulfur, and selenium. The aryl group may be a C2 to C30 heteroary group having the atom having an unshared electron pair as a ring member. The heteroaryl group may be monocyclic aromatic compound or polycyclic aromatic compound having fused aromatic rings. For example, the heteroaryl group may include pyridines such as pyridine, pyrazine, pyridazine, pyrimidine, triazine, tetrazine, oxazine, thiazine and selenazine; pyrroles such as pyrrole, pyrazole, imidazole, dihydrothiazole, dihydrooxazole, dihydroselenazole, triazole, dihydrooxadiazole, dihydrothiadiazole and dihydroselenadiazole; and thiophenes such as thiophene, isothiazole, thiazole, dithiole, oxathiole, thiaselenole, thiadiazole, oxathiazole, dithiazole and thiaselenazole.

In Formula 1, R₁ may be a substituted or unsubstituted C1 to C12 alkyl group, for example, unsubstituted C4 to C10 alkyl group. Also, R₁ may be a linear alkyl group.

In Formulae 14-16, R₁ and R₄ may each independently be a bond to the adjacent R₃, a hydrogen group, a substituted or unsubstituted C1 to C12 alkyl group, or a substituted or unsubstituted C2 to C30 aryl group; and R₂ and R₃ may each independently be a substituted or unsubstituted C1 to C12 alkyl group, or a substituted or unsubstituted C2 to C30 aryl group.

The compounds represented by Formulae 1 to 11, 14, and 16 are oligomers or polymers. In Formulae 1 to 11, 14, and 16 n may be a number from 1 to 10,000,000. In Formulae 1 to 3, 8, and 9 m may be a number from 1 to 10,000,000. In Formula 9, o may be a number from 1 to 10,000,000. Specifically, n may be a number from 2 to 10,000,000, m may be a number from 2 to 10,000,000, and o may be a number from 2 to 10,000,000. The main materials represented by Formulae 1 to 3, 8, and 9 may be block copolymers. The main materials represented by Formulae 4 to 7, 10, 11, 14, and 16 may be homopolymers. The main materials represented by Formulae 12, 13, and 15 may be organic monomers. A ratio of n to m of the block copolymers of Formulae 1 to 3 satisfies the condition of 0<n/(n+m)<1. The ratio is preferably in the range from 0.1 to 0.9, and more preferably, from 0.3 to 0.7. Also, the block copolymers may have a micelle structure.

The main materials represented by Formulae 7 to 13 having π-conjudated backbone may have conductance showing various degrees.

The main material represented by Formula 1 may be the composition of the following Formula 1a.

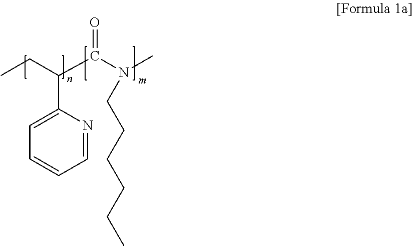

In Formula 1a, n and m are defined as for Formula 1.

The main material represented by Formula 2 may be the composition of the following Formula 2a.

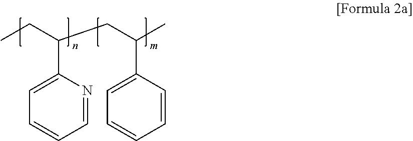

In Formula 2a, n and m are defined as for Formula 2.

The main material represented by Formula 3 may be the composition of the following Formula 3a.

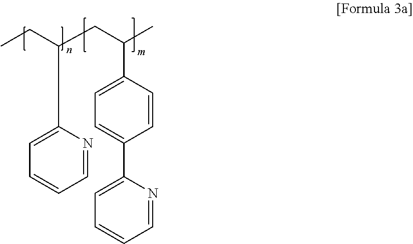

In Formula 3a, n and m are defined as for Formula 3.

The main material represented by Formula 4 may be the composition of the following Formula 4a.

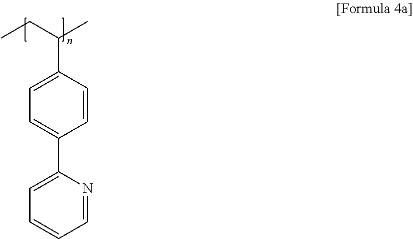

In Formula 4a, n is defined as for Formula 4.

The main material represented by Formula 5 may be the composition of the following Formula 5a.

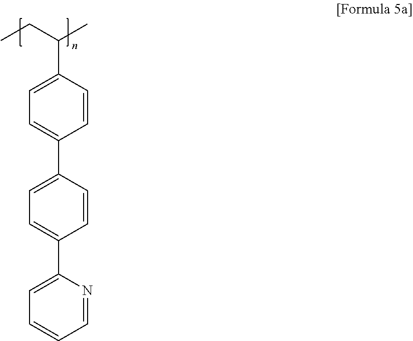

In Formula 5a, n is defined as for Formula 5.

The main material represented by Formula 6 may be one of the compositions of the following Formulae 6a and 6b.

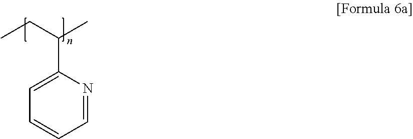

In Formula 6a, n is defined as for Formula 6.

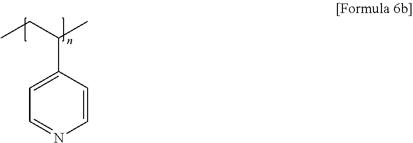

In Formula 6b, n is defined as for Formula 6.

The main material represented by Formula 8 may be the composition of the following Formula 8a.

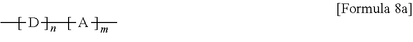

In Formula 8a, D is an electron donor material, A is an electron acceptor material and n and m are defined as for Formula 8.

The main material represented by Formula 9 may be one of the compositions of the following Formulae 9a and 9b.

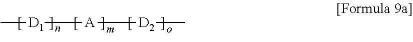

In Formula 9a, D₁ and D₂ are the same or different electron donor materials, A is an electron acceptor material, and n, m, and o are defined as for Formula 9.

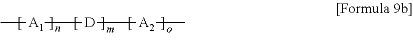

In Formula 9b, D is an electron donor material, A₁ and A₂ are the same or different electron acceptor materials, and n, m, and o are defined as for Formula 9.

The main material represented by Formula 12 may be one of the compositions of the following Formulae 12a, 12b, and 12c.

D-A [Formula 12a]

In Formula 12a, D is an electron donor material, and A is an electron acceptor material.

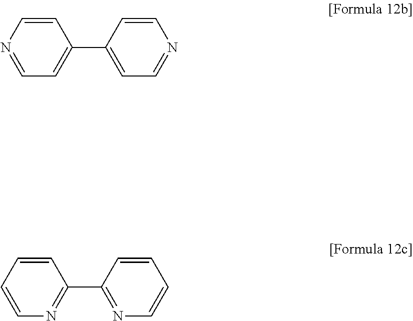 [SMILES: c1cc(-c2ccncc2)ccn1 ; c1ccc(-c2ccccn2)nc1]

The main material represented by Formula 13 may be one of the compositions of the following Formulae 13a and 13b.

D₁-A-D₂ [Formula 13a]

In Formula 13a, D₁ and D₂ are the same or different electron donor materials, and A is an electron acceptor material.

A₁-D-A₂ [Formula 13b]

In Formula 13b, D is an electron donor material, and A₁ and A₂ are the same or different electron acceptor materials.

In Formulae 8a, 9a, 9b, 12a, 13a, and 13b, D₁ and D₂ may each independently be a substituted or unsubstituted thiophene group, or a substituted or unsubstituted carbazole group. The substituted thiophene group may be 3,4-ethylenedioxythiophene, 3-hexylthiophene, thieno[3,2-b]thiophene, or dithieno[3,2-b:2′,3′-d]thiophene. A₁ and A₂ may each independently be a substituted or unsubstituted thienopyrroledione group, a substituted or unsubstituted diketopyrrolopyrrole group, a substituted or unsubstituted indolinone group, or a substituted or unsubstituted isoindigo group.

The main material represented by Formula 14 may be the composition of the following Formula 14a.

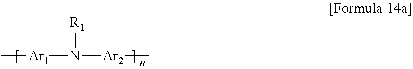

In Formula 14a, Ar₁ and Ar₂ may each independently be a substituted or unsubstituted C2 to C30 aryl group, and R₁ may be a bond to the Ar₂, a hydrogen group, a substituted or unsubstituted C1 to C12 alkyl group, or a substituted or unsubstituted C2 to C30 aryl group, and n may be a number from 2 to 10,000,000.

The main material represented by Formula 15 may be the composition of the following Formula 15a.

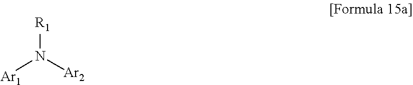

In Formula 15a, Ar₁ and Ar₂ may each independently be a substituted or unsubstituted C2 to C30 aryl group, and R₁ may be a bond to the Ar₂, a hydrogen group, a substituted or unsubstituted C1 to C12 alkyl group, or a substituted or unsubstituted C2 to C30 aryl group.

The main material represented by Formula 16 may be the composition of the following Formula 16a.

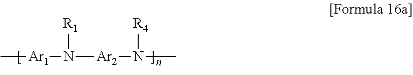

In Formula 16a, Ar₁ and Ar₂ may each independently be a substituted or unsubstituted C2 to C30 aryl group, R₁ and R₄ may each independently be a bond to the Ar₂, a hydrogen group, a substituted or unsubstituted C1 to C12 alkyl group, or a substituted or unsubstituted C2 to C30 aryl group, and n may be a number from 2 to 10,000,000. In Formulae 14a, 15a, and 16a, the aryl group may be a heteroaryl group including at least one atom having an unshared electron pair. The atom having an unshared electron pair may be selected from the group consisting of nitrogen, phosphorus, oxygen, sulfur, and selenium. The heteroaryl group may be monocyclic aromatic compound or polycyclic aromatic compound having fused aromatic rings. For example, the heteroaryl group may include pyridines such as pyridine, pyrazine, pyridazine, pyrimidine, triazine, tetrazine, oxazine, thiazine and selenazine; pyrroles such as pyrrole, pyrazole, imidazole, dihydrothiazole, dihydrooxazole, dihydroselenazole, triazole, dihydrooxadiazole, dihydrothiadiazole and dihydroselenadiazole; and thiophenes such as thiophene, isothiazole, thiazole, dithiole, oxathiole, thiaselenole, thiadiazole, oxathiazole, dithiazole and thiaselenazole.

The main materials represented by Formulae 14a, 15a, and 16a having π-conjudated backbone may have conductance showing various degrees. An unshared electron pair on nitrogen in Formulae 14a, 15a, and 16a can participate π-conjugation.

The linking material may combine with the functional group in the adjacent main material by quaternization, organic material-metal interaction, ionic bonding, or hydrogen bonding. The linking material may be the compositions of the following Formula 17 or Formula 18, a homopolymer or a block copolymer including the repeating unit of the following Formula 19, or a metal salt of the following Formula 20.

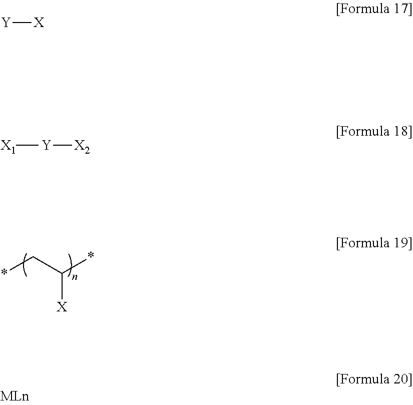

In Formulae 17 and 18, Y may be a substituted or unsubstituted C1 to C8 alkyl group, or a substituted or unsubstituted C2 to C30 aryl group, a substituted or unsubstituted polyaryl group having 2 to 8 repeating C2 to C30 aryl groups, or a substituted or unsubstituted ferrocene group. The alkyl group may be a linear saturated C2 to C6 alkyl group. The aryl group may be a phenyl group or heteroaryl group. The polyaryl group may be a polyphenyl group or polyheteroaryl group.

In Formulae 17 to 19, X, X₁, and X₂ may each independently be a halogen group, an acidic functional group, or a functional group for hydrogen bonding. The halogen group may be a Cl group, a Br group, or an I group. The acidic functional group may be a OH group, a COOH group, a SO₃H group, or a PO₄H₂ group, but is not limited thereto. The functional group for hydrogen bonding may be a OH group, a SH group, a COOH group, or a NH₂ group, but is not limited thereto.

In Formula 19, n may be a number from 1 to 10,000,000, for example, 2 to 10,000,000. In Formula 20, M may be a metal such as Zn, Cu, Pd, Ru, or Pt, but is not limited thereto, L may be a ligand such as a Cl group, a Br group, an I group, a OH group, a NO3 group, or oxylate group, but is not limited thereto, n may be a number of 1 to 8, but is not limited thereto.

The linking material represented by Formula 17 may be one of the compositions of the following Formulae 17a and 17b.

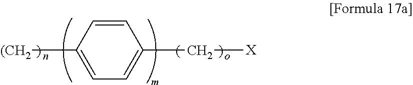

In Formula 17a, X is defined as for Formula 17, and n, m, and o may each independently be 0 to 8, provided that the sum of n, m, and o is the number of 1 to 8.

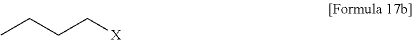

In Formula 17b, X is defined as for Formula 17.

The linking material represented by Formula 18 may be one of the compositions of the following Formulae 18a, 18b, 18c, and 18d.

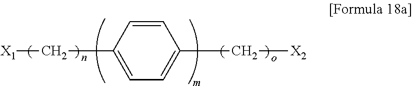

In Formula 18a, X₁, and X₂ are defined as for Formula 18, and n, m, and o may each independently be 0 to 8, provided that the sum of n, m, and o is the number of 1 to 8.

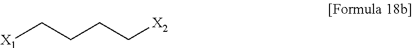

In Formula 18b, X₁, and X₂ are defined as for Formula 18.

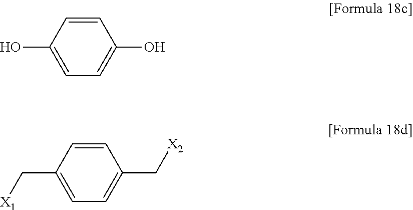

In Formula 18d, X₁, and X₂ are defined as for Formula 18.

In case that the linking material is the composition of Formula 17, 18, or 19, and X, X₁ or X₂ in Formula 17, 18, or 19 is the halogen group, quaternization between the halogen group from the linking material and the atom having an unshared electron pair, for example, nitrogen from the main material can be achieved.

In case that the linking material is the composition of Formula 17, 18, or 19, and X, X₁ or X₂ in Formula 17, 18, or 19 is the functional group for hydrogen bonding such as a OH group, a SH group, a COOH group, or a NH₂ group, hydrogen bonding between the functional group from the linking material and the atom having an unshared electron pair, for example, oxygen from the main material can be achieved.

In case that the linking material is the composition of Formula 17, 18, or 19, and X, X₁ or X₂ in Formula 17, 18, or 19 is the acidic group such as a OH group, a COOH group, a SO₃H group, or a PO₄H₂ group, ionic bonding following protonization between the acidic group from the linking material and the atom having an unshared electron pair, for example, sulfur from the main material can be achieved.

In case that the linking material is a metal salt such as the compound of Formula 20, organic material-metal interaction (or organic material-metal coordination) between the metal ion from the linking material and the atom having an unshared electron pair from the main material can be achieved.

In the present embodiment, after conditions are formed for building a micelle- or film-type nano structure using block copolymers, homopolymers or monomers of Formulae 1 to 16 for a main material in a selective solvent, a linking material of Formulae 17 to 20 is introduced into the solution, so as to form an organic crystalline structure through quaternization, organic material-metal interaction, ionic bonding, or hydrogen bonding.

Various electrical characteristics can be obtained using the nano structure whose crystalline structure is differently controlled on a scale of nanometers according to a variety of concentrations and fractions of the main material and linking materials. The nano crystalline structure thus built is analyzed using transmission electron microscopes (FE-TEM and FE-SEM), atomic force microscopes (AFM), dynamic light scattering and x-ray diffraction (XRD) equipment. Finally, an electronic device is created using the crystallized nano structure, and its electrical characteristics are estimated.

In the present embodiment, methods of forming and controlling a several nanometer-sized nano structure formed in uniform arrangement by combination between polymers or monomers for the main material, and linking materials capable of quaternization, organic material-metal interaction, ionic bonding or hydrogen bonding will be descried in detail. However, homopolymers such as poly(vinylpyridine) (P2VP), poly(vinylphenylpyridine) (PP2VP) and poly(vinylbiphenylpyridine) (PPP2VP) also can be used for the main material, and various organic and metal materials having a functional group capable of polar-polar interaction with the main material can be used for the cross-linkable linking material. Although the block copolymers, homopolymers and monomers having pyridines are used as the main material in the present embodiments, materials having functional groups capable of forming quaternization, organic material-metal interaction, ionic bonding, and hydrogen bonding with the linking material, e.g., thiophene and thiazole groups, also may be used as the main material. The present invention will now be described in more detail with reference to specific exemplary embodiments, which are not intended to limit the scope of the invention.

### Example 1

### Formation of Organic Crystalline Structure Using Block Copolymer

An amount of a linking material cross-linking with a block copolymer main material of Formulae 1a, 2a or 3a may be about 50, about 75 or about 100 mole % based on the vinyl pyridine unit in poly(2-vinylpyridine) of the block copolymer. The block copolymer may be dissolved in a selective organic solvent, the linking material may be dispersed in the solution in a calculated molar ratio, and the solution may be agitated to form sufficient cross-links.

First, the block copolymer listed above may be dissolved in a selective solvent. The organic solvent may be a common organic solvent, specifically, methanol, tetrahydrofurane (THF), or a mixture thereof. The block copolymer may be dissolved in the solvent to a concentration of from about 0.5 to about 10 g/l. Here, the block copolymer may be dissolved at a temperature ranging from about 15 to about 40° C., and preferably about 20 to about 30° C., for about 10 hours by agitation.

The 50, 75 and 100 mole % linkin materials, calculated by considering the mole of the vinylpyridine unit, may be dispersed in the micelle-type polymer solution prepared from the block copolymer by the above method and agitated for about 24 to about 180 hours depending on the kind of the linking material.

In the present embodiment, coil-rod-shaped block copolymer of poly(2-vinylpyridine)-block-poly(n-hexylisocyanate) or coil-coil-shaped block copolymer of poly(2-vinylpyridine)-block-poly(styrene) is an amphiphilic polymer having both hydrophilic and hydrophobic groups, and is thus suitable for self-assembly. Hence, the copolymer could form a uniform micelle-structure nano particle or a phase-separated lamella nano structure depending on choice of the selective solvent. A several nanometer-sized uniform crystalline structure could be obtained from an organic nano structure, and various results could be obtained by differing aspects such as a distance between crystals by adjusting the concentration of the block copolymer (main material), the molar ratio of the main material to the linking material, the kind of the organic solvent and the amounts of additives.

### Preparation Example 1

### Preparation of Block Copolymer of poly(2-vinylpyridine)-block-poly(n-hexylisocyanate) (P2VP-b-PHIC)

To synthesize a block copolymer of P2VP-b-PHIC, polymerization was performed with 2-vinylpyridine as a first monomer in the solvent of tetrahydrofurane (THF) at −78° C. under a high vacuum of 10-6 torr for 30 minutes. The temperature was cooled down to −78° C. by adding dry ice in a constant-temperature bath with acetone.

A polymerization reactor including glass ampoules containing a purified initiator (DPM-K), monomers (2VP and n-HIC), additives (sodium tetraphenylborate; NaBPh4), a terminating agent (methanol-acetic acid) and a washing solution, was sealed off from the vacuum line. The sealed reactor was washed by the ampoule containing the washing solution, and then the initiator was introduced into the polymerization reactor by breaking its ampoule. The polymerization reactor was placed in the constant-temperature bath with acetone to reach temperature equilibrium (−78° C.), and 2VP was introduced thereto and reacted for 30 minutes.

After that, some of the poly(2-vinylpyridine) homopolymer solution was transferred to a tube for homopolymer, and the additive, sodium tetraphenylborate, was introduced into a main reactor to convert a counter cation into a sodium ion from a potassium ion. The reactor was transferred to the constant-temperature bath which is set to −98° C. by adding liquid nitrogen to methanol to reach temperature equilibrium. Then, n-hexylisocyanate, a second monomer, was introduced into the reactor and reacted for 20 minutes.

The polymerization was terminated by adding a methanol-acetic acid mixture as a terminating agent. The polymer thus obtained was precipitated in excess methanol and dried by vacuum-drying or freeze-drying.

### Preparation Example 2

### Preparation of block copolymer of poly(2-vinylpridine)-block-polystyrene (P2VP-b-PS)

To synthesize P2VP-b-PS block copolymer of Formula 2a, polymerization was performed using styrene as a first monomer at −78° C. in a THF solvent in an atmosphere of nitrogen. The temperature was cooled down to −78° C. by adding dry ice in a constant-temperature bath with acetone.

First, an initiator of sec-butyl lithium was added to initiate the polymerization of styrene dissolved in the THF solvent. The polymerization was performed for 30 minutes. After that, to weaken activity of a living polystyryl anion, an additive of 1,1-diphenyl ethylene solution was dissolved in the polystyrene solution. The reaction was performed for 30 minutes. Then, a 2VP solution was added to the polystyrene solution for second polymerization. After terminating the reaction, a resulting polymer was precipitated in excess methanol and hexane, and melted in benzene, followed by freeze-drying the mixture.

Schemes 1 to 6 are examples of cross-linking and quaternizing with 1,4-dibromobutane or 1-bromobutane linking material using a block copolymer template.

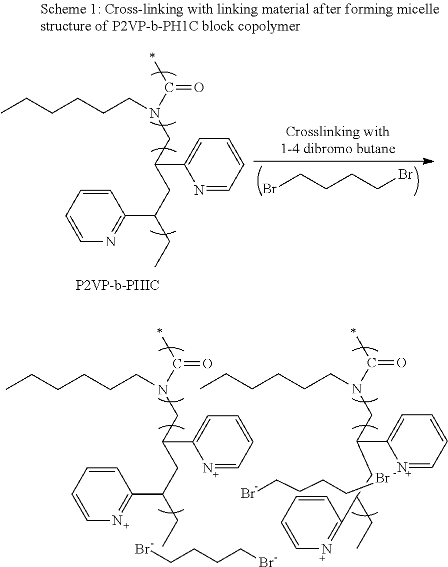

A P2VP-b-PHIC block copolymer prepared according to Example 1 was added to a mixed solvent of methanol and THF or toluene and THF in a volume ratio of 8:2, and agitated at a constant speed for 10 hours.

Afterward, 100 mole % linking material (1,4-dibromobutane, an example of Formula 18a), calculated based on the mole of a vinyl pyridine unit in poly(2-vinylpyridine) of the block copolymer, was dispersed in the polymer micelle solution prepared from the block copolymer by the method described above, and agitated for 24 to 180 hours depending on the kind of the linking material.

The block copolymer cross-linked with the vinyl pyridine unit from the poly(2-vinylpyridine) of the block copolymer and a micelle template formed a film whose structure and physical properties were then analyzed using FE-TEM, FE-SEM, XRD and DLS equipment.

The block copolymer thus prepared had a molecular weight of 26.2 kg/mol and a P2VP mole fraction of 0.85. The copolymer was dissolved in a mixed solvent of methanol and THF in a volume ratio of 8:2 to a concentration of from 0.2 to 10 g/l. Here, 100 mole % of linking material (1,4-dibromobutane) based on the mole of the vinyl pyridine unit in poly(2-vinyl pyridine) of the block copolymer was used.

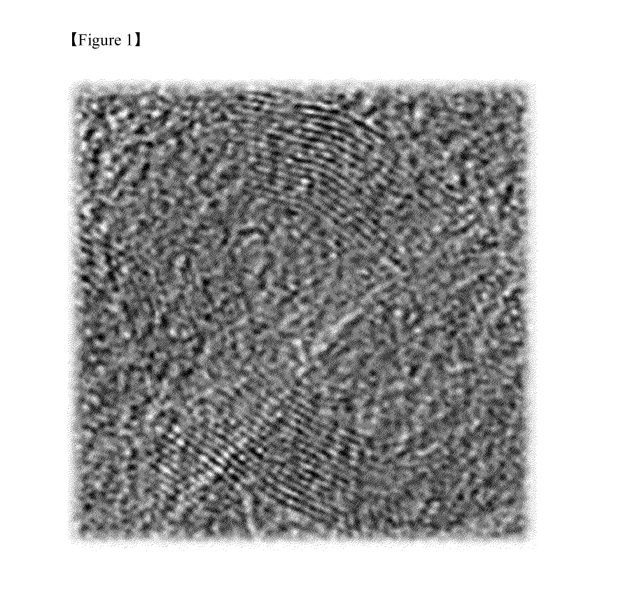

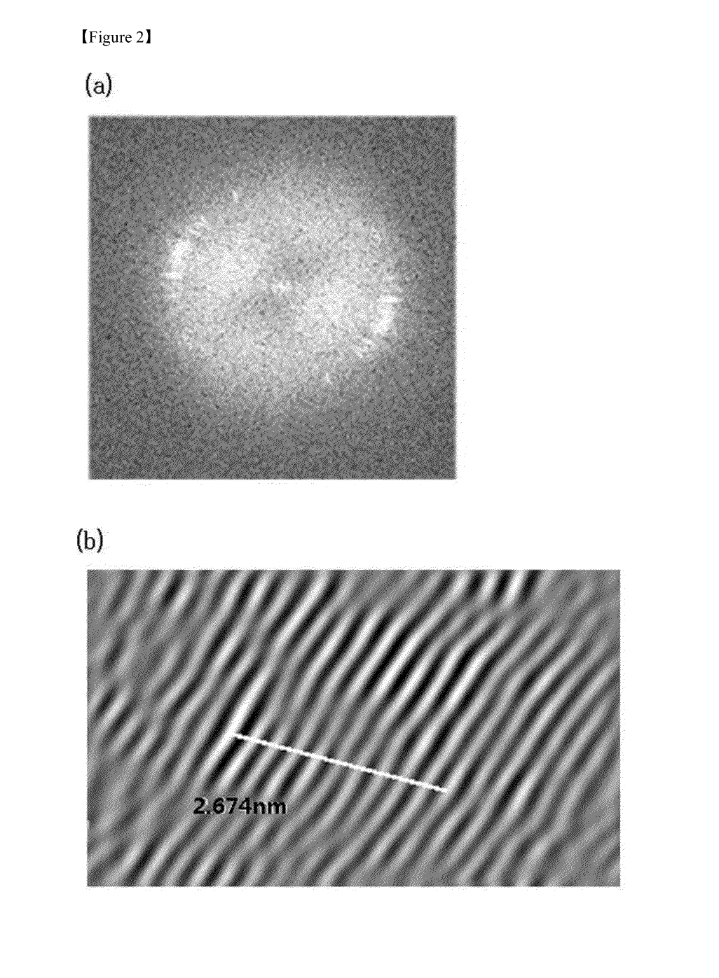

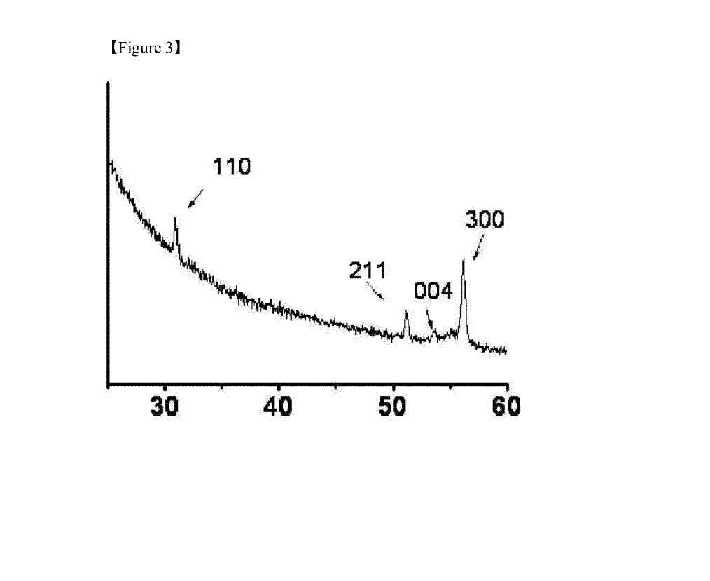

As seen from the high-resolution (HR)-TEM image and its Fast Fourier Transform for the cross-linked micelle of FIGS. 1 and 2, a P2VP domain is placed outside the micelle, whereas a PHIC domain is placed inside the micelle, and a distance between pattern lines is 0.267 nm in the P2VP domain of the micelle, which corresponds to the XRD result of FIG. 3.

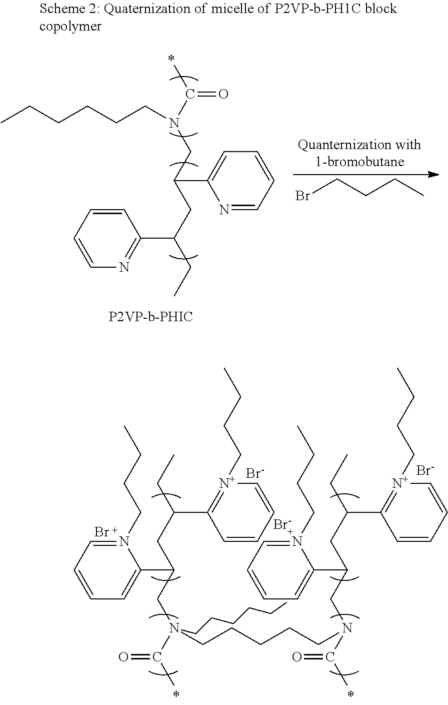

The P2VP-b-PHIC copolymer prepared according to Preparation example 1 was added to a mixed solvent of toluene and THF in a volume ratio of 8:2, and agitated at a constant speed for 10 hours.

Afterward, a specific amount of 1-bromobutane (an example of Formula 17a), calculated by considering the mole fraction of the vinylpyridine unit in poly(2-vinylpyridine) of the block copolymer, was dispersed in the polymer micelle solution prepared from the block copolymer by the method described above, and agitated at a constant speed for 10 hours. Through these procedures, nitrogen from pyridine of the block copolymer was quaternized with bromine from 1-bromobutane.

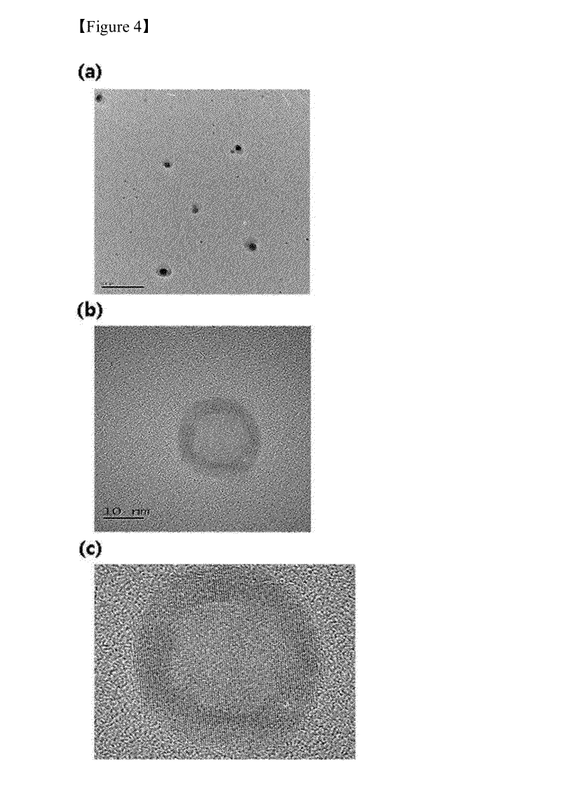

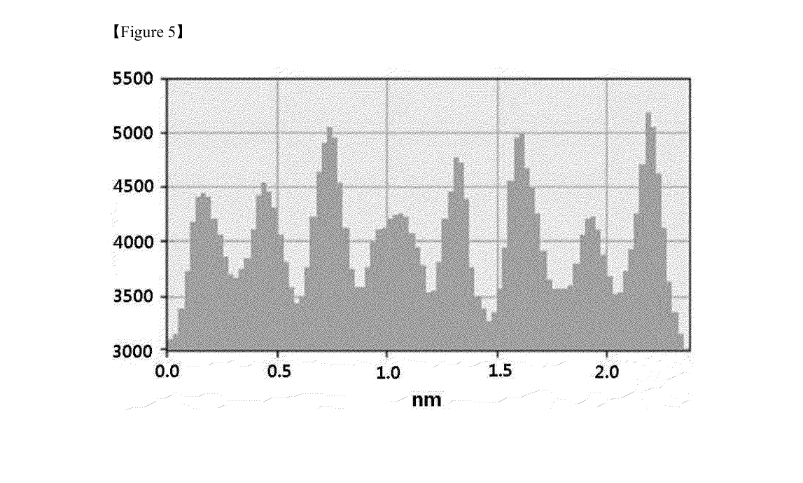

FIG. 4 shows a crystalline structure of P2VP-b-PHIC micelle quaternized by the above procedures. As seen from the density distribution of fringe spacings in FIG. 5, a distance between crystals is maintained at an average of 0.275 nm.

### Scheme 3

### Cross-Linking of Large-Sized Polymer Film-Type Nano Structure Using P2VP-b-PHIC Block Copolymer

The present example is almost the same as Scheme 2, other than the kinds of a solvent used. That is, depending on a solvent used, a film-type structure, other than the micelle-type structure, can be formed.

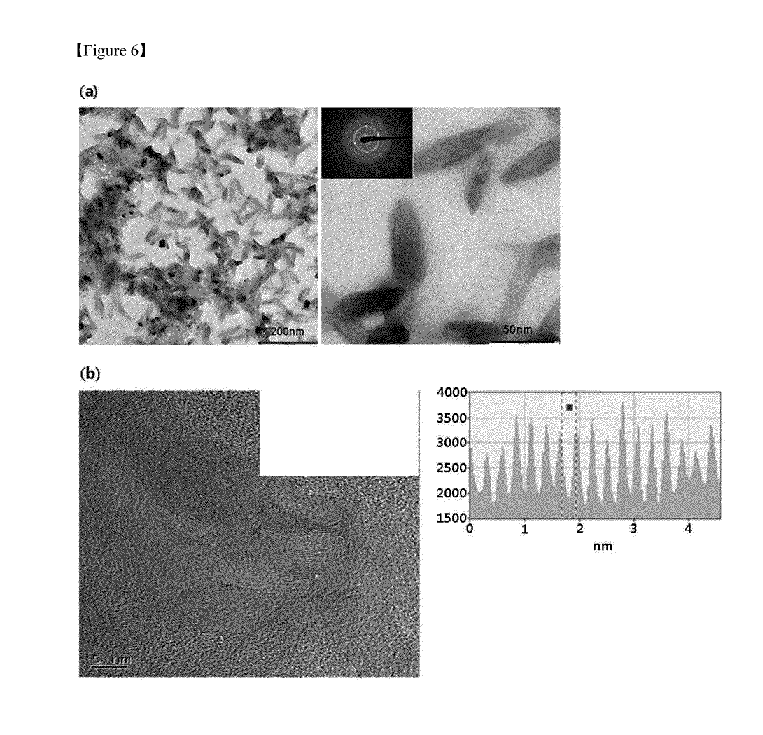

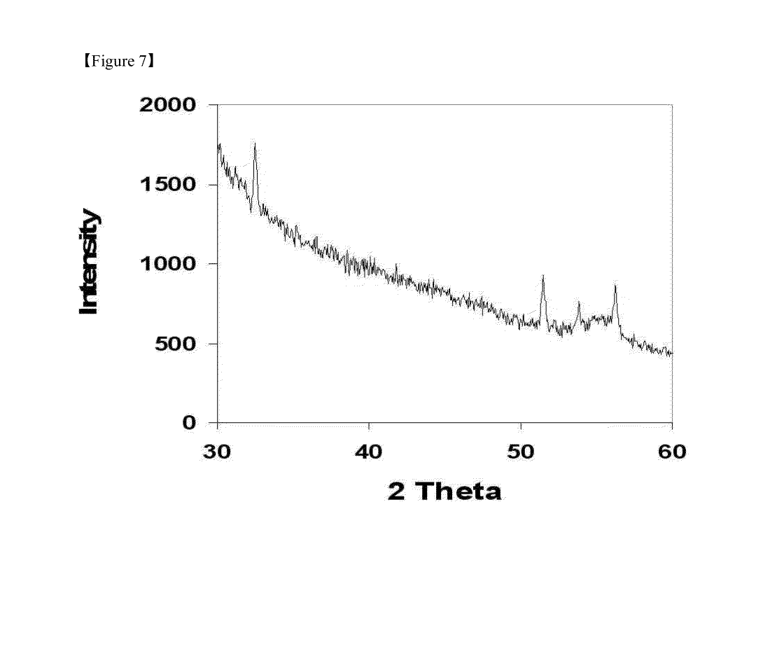

The block copolymer (P2VP-b-PHIC) prepared according to Preparation example 1 was dispersed in the solvent of THF in a concentration of 0.1 to 1 mg/ml, and agitated at a constant speed for 10 hours. In consideration of the mole fraction of the vinylpyridine unit in poly(2-vinylpyridine) of the block copolymer, a specific amount of 1-bromobutane (an example of Formula 17a) was dispersed in the polymer micelle solution prepared from the block copolymer by the method described above, and then agitated at a constant speed for 10 hours. Through these procedures, nitrogen from pyridine of the block copolymer was quaternized with bromine from 1-bromobutane. FIG. 6(a) shows an EF-TEM image and its XRD result for the polymer film formed by quaternizing P2VP-b-PHIC dispersed in the THF solvent in a concentration of 0.1 to 1 mg/ml with 1-dibromobutane, and FIG. 6(b) shows an HR-TEM image and a density distribution of fringe spacings in the organic nano crystalline structure. FIG. 7 shows an XRD result for the quaternized polymer film.

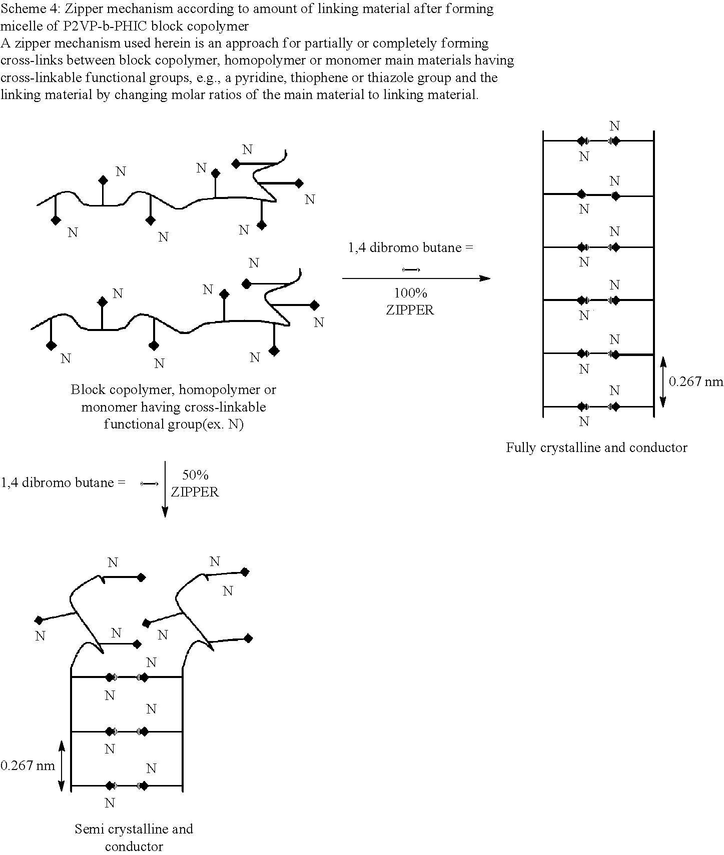

That is, when a block copolymer having a cross-linkable functional group was present in the solution in the following reaction formula, polymer chains formed from block copolymer were combined with the aid of adjacent linking materials like zippers according to the amounts of the main material and the linking material.

The P2VP-b-PHIC block copolymer prepared according to Preparation example 1 is added to a mixed solvent of methanol and THF or toluene and THF in a volume ratio of 8:2, and agitated at a constant speed for 10 hours. Afterward, 50, 75 and 100 mole % of linking materials (1,4-dibromobutane), calculated based on the mole of the vinyl pyridine unit from poly(2-vinylpyridine) of the block copolymer, were dispersed in the polymer micelle solution prepared from the block copolymer by the method described above, and agitated from 24 to 180 hours depending on the kind of the linking materials. Thus, from the results combined by the zipper mechanism, it can be seen that the amount of the nano crystalline structure observed in the P2VP domain can be dependant on the amount of the dispersed linking material.

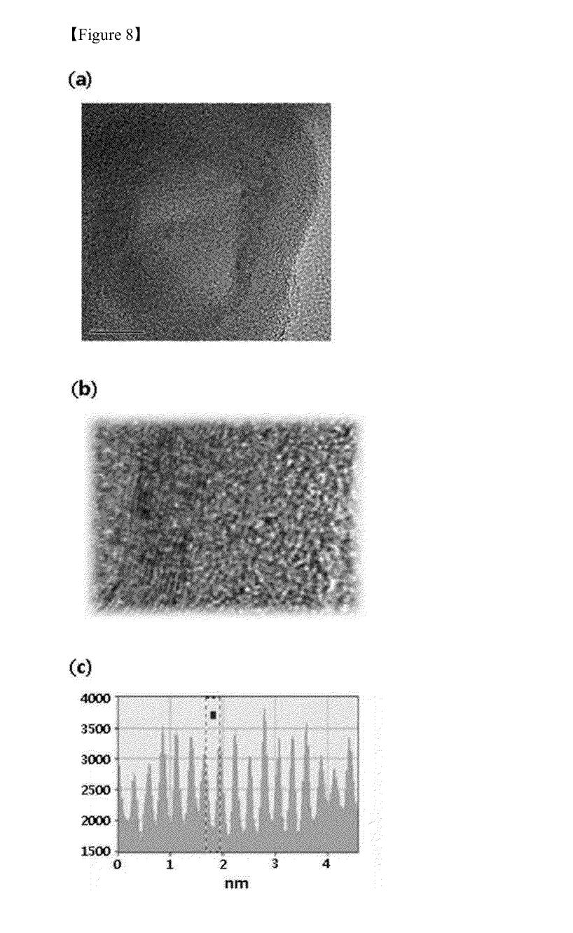

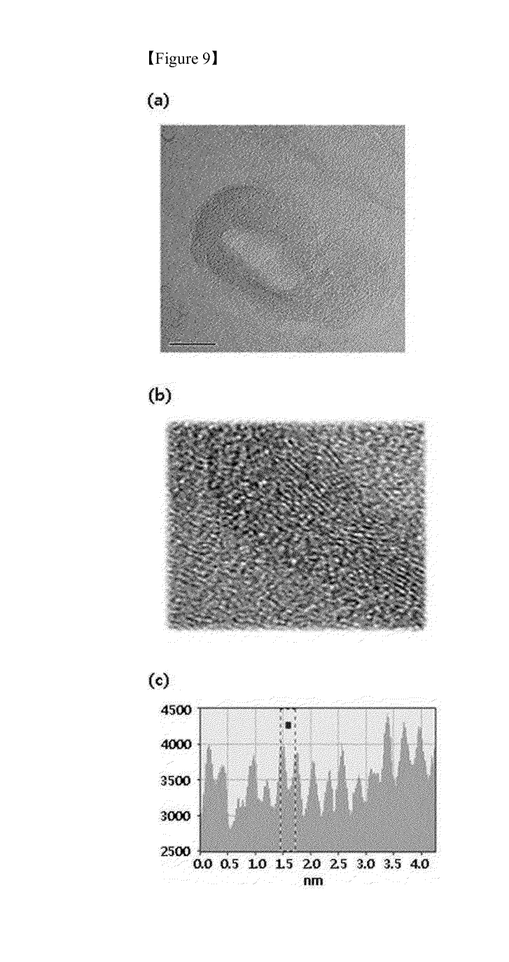

That is, FIG. 1 shows results obtained using 100 mole % of the linking material, FIG. 8 shows results obtained using 75 mole % of linking material, and FIG. 9 shows results obtained using 50 mole % of linking material based on the mole of the vinyl pyridine unit. In the case of 100 mole % of linking material, the nano crystalline structure can be observed in a larger area of the P2VP domain, whereas in the case of 50% linking material, the nano crystalline structure can be observed in a smaller area.

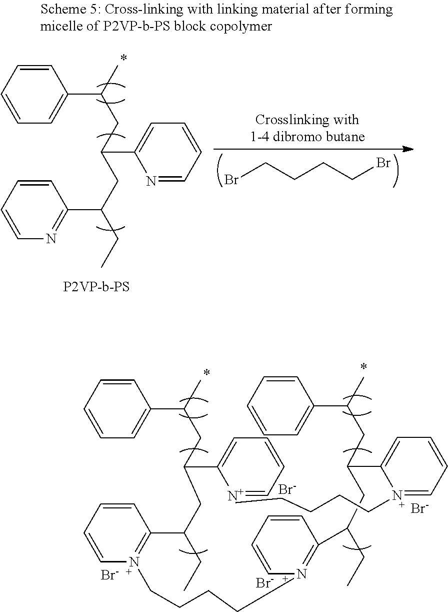

The P2VP-b-PS block copolymer prepared according to Preparation example 2 was dissolved in a 100% pure methanol solvent and then agitated at a constant speed for 10 hours. After that, 100 mole % of linking material (1,4-dibromobutane), based on the mole of the vinyl pyridine unit in the poly(2-vinyl pyridine) of the block copolymer, was dispersed in the polymer micelle solution prepared from the block copolymer by the method described above, and then agitated for 24 to 180 hours depending on the kind of the linking material.

The block copolymer thus prepared had a molecular weight of 120 kg/mol and a P2VP mole fraction of 0.50. The block polymer was dissolved in a mixed solvent of methanol and THF in a volume ratio of 8:2 to a concentration of from 0.2 to 10 g/l. Here, 50, 75 and 100 mole % of linking materials based on the mole of the vinyl pyridine unit in poly(2-vinyl pyridine) of the block copolymer were used.

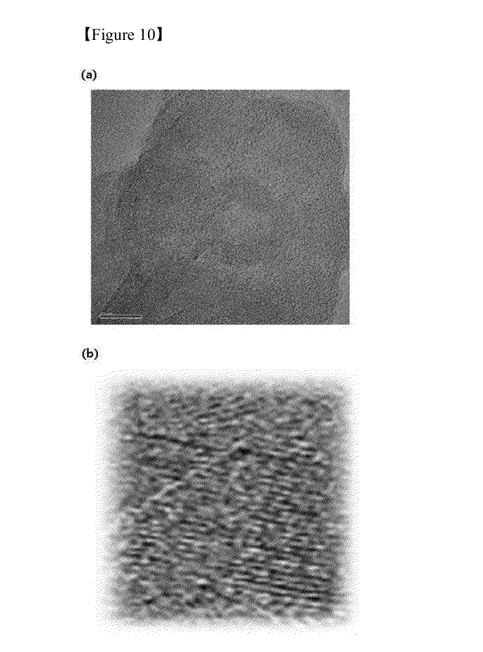

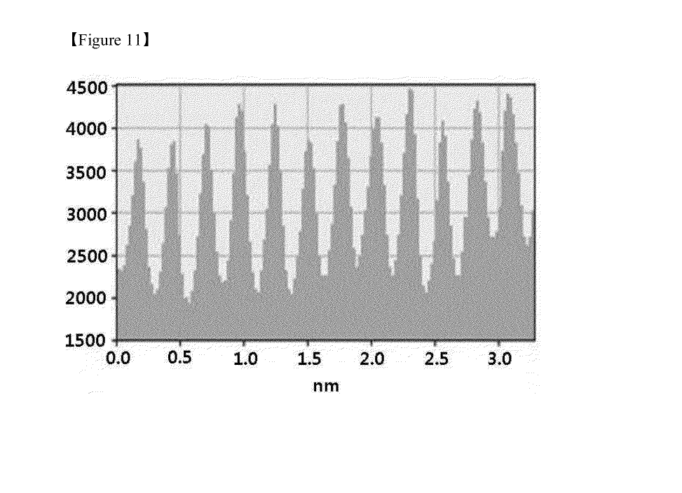

FIG. 10 shows an HR-TEM image for P2VP-b-PS block copolymer after cross-linking. From the results, it can be seen that the P2VP domain is placed outside the micelle structure, whereas the PS domain is placed inside the micelle structure. It can be seen from the density distribution of fringe spacings shown in FIG. 11 that fringe spacing is 0.276 nm.

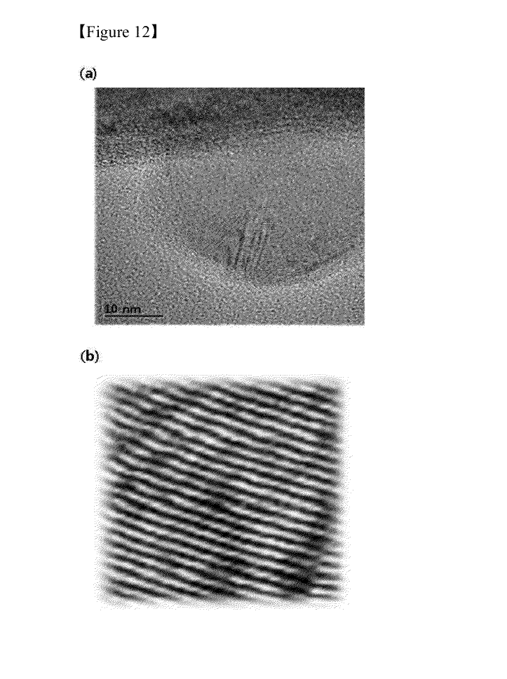

In the mixed solvent of toluene and methanol in a volume ratio of 8:2, according to FIG. 12, the P2VP domain is placed inside the micelle structure, whereas the PS domain is placed outside the micelle structure. According to the density distribution of fringe spacings, the fringe spacing is 0.276 nm.

### Scheme 6

### Formation of Polymer Nano Thin Film Structure by Cross-Linking of poly(phenyl-2-vinylpyridine)-block-poly(2-vinlypyridine) (PP2VP-b-P2VP) Block Copolymer

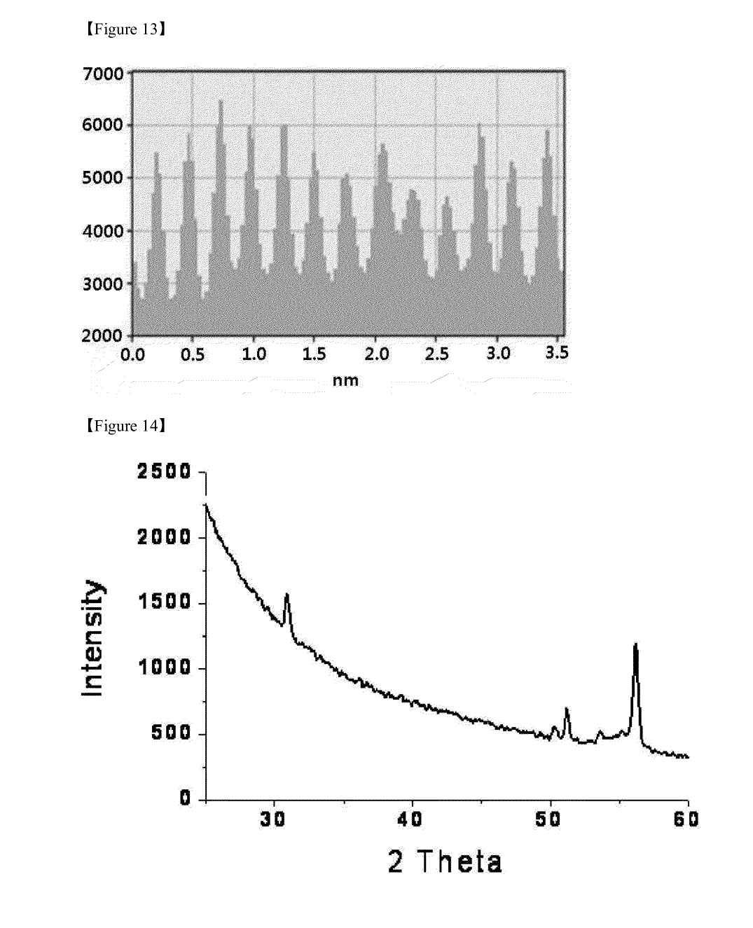

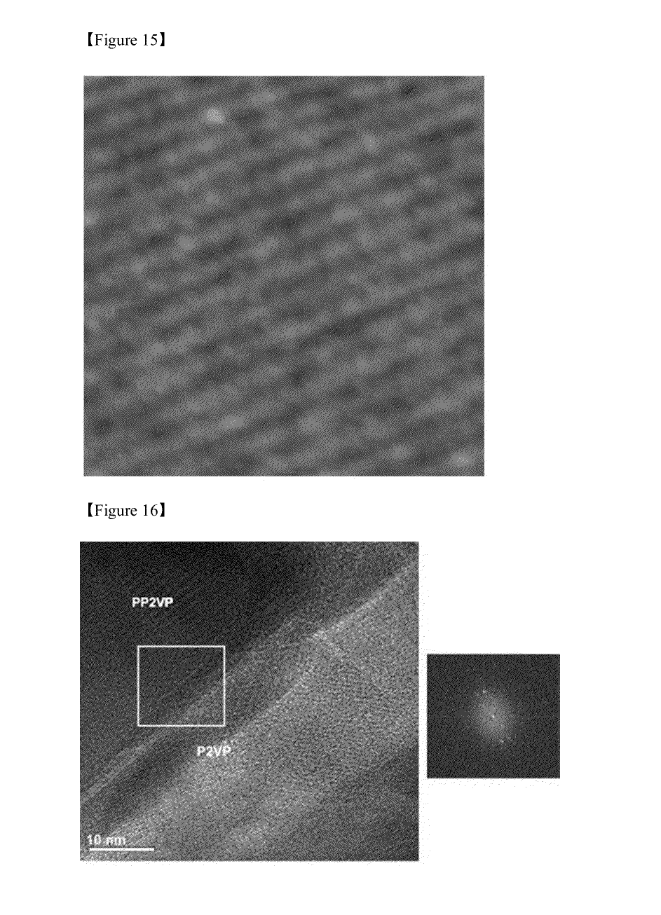

0.5 to 5 mg/ml of PP2VP-b-P2VP block copolymer was dissolved in the solvent of THF and agitated at a constant speed for 10 hours. After that, a specific amount of 1,4-dibromobutane, calculated based on the mole of the vinyl pyridine unit from poly(2-vinyl pyridine) of the block copolymer, was dispersed in the polymer solution prepared from the block copolymer by the method described above, and agitated at a constant speed for 10 hours. Through the above procedure, quaternization between bromine from 1,4-dibromobutane and nitrogen from pyridine of the block copolymer was achieved. FIG. 15 shows an AFM image for a polymer film cross-linked with 1,5-dibrombutne in the PP2VP-b-P2VP block copolymer dissolved in the THF solvent. FIG. 16 shows an HR-TEM image and an XRD result for the product of the above procedure.

### Example 2

### Formation of Organic Crystalline Structure Using Homopolymer

To nano-crystallize homopolymers of Formulae 4 to 7 and 10 to 11 for a main material, the homopolymer may be mixed with an intermediate material for a linking material (Formulae 17 to 19) in a ratio of 1:1, nitrogen gas may be injected into the mixture, and the mixture may be agitated at room temperature to induce interaction between functional groups of the homopolymer and the linking material by quaternization, hydrogen bonding, ionic bonding, or organic material-metal interaction.

After agitation, the mixture may be coated on a silicon wafer. Here, to give crystallinity, the mixture coated on the silicon wafer may be stored at room temperature for about three days to slowly evaporate a solvent. Then, a film from which the solvent is slowly evaporated may be dried in an oven at about 60° C. for about 6 hours.

In the present embodiment, Schemes 7 and 8 show examples of reaction between a linking material and a homopolymer main material.

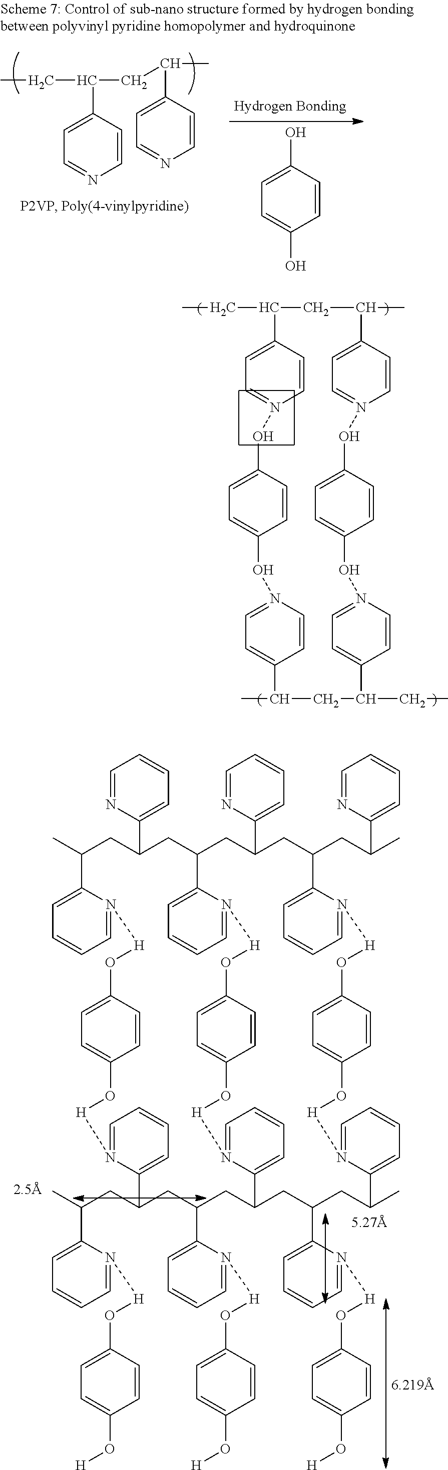

Hydroquinone (Formula 18c) was added to poly(2-vinylpyridine) of Formula 6a and poly(4-vinyl pyridine) of Formula 6b, respectively, in the solvent of methanol, and then agitated at a constant speed for 10 hours. Here, the molar ratio of pyridine to hydroquinone is 1:1, and the agitation was performed in an atmosphere of nitrogen gas at room temperature to form hydrogen bonding between nitrogen from the pyridine and an alcoholic group from the hydroquinone. After that, the mixture was coated on a silicon wafer. Here, to give crystallinity, the mixture coated on the silicon wafer was stored for three days at room temperature to slowly evaporate the solvent therefrom. A film formed by slowly evaporating the solvent for three days was dried in an oven at 60° C. for 6 hours.

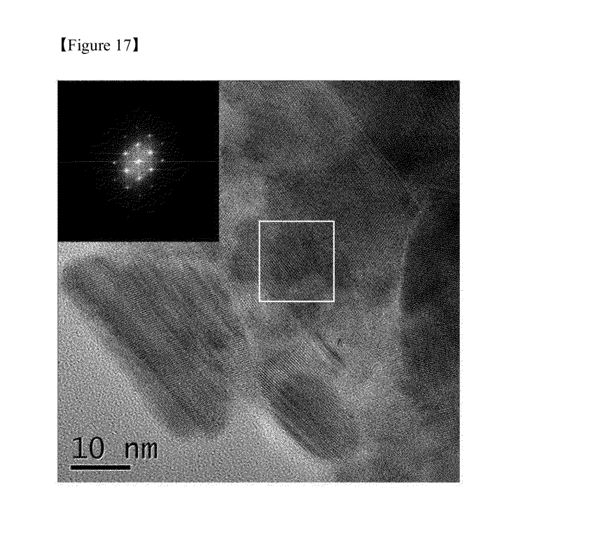

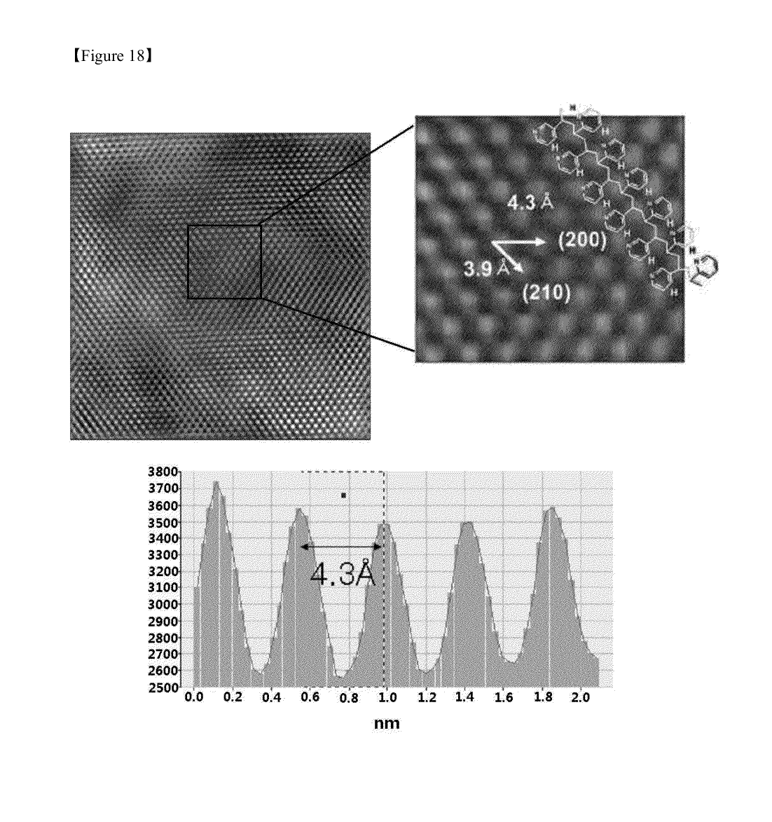

The crystallinity and sub-nano structure of the film thus obtained were analyzed by XRD and HR-TEM. The XRD result reveals that both amorphous polymers, i.e., poly(2-vinyl pyridine) and poly(4-vinyl pyridine), were combined with hydroquinone by hydrogen bonding and exhibited crystallinity, and the HR-TEM result reveals a lattice image in the sub-nano structure. And, XRD peaks closely match the crystalline structure observed from the HR-TEM lattice image. FIG. 17 shows an HR-TEM image and an XRD result for a nano crystalline structure of a monomer film cross-linked with hydroquinone by hydrogen bonding in poly(2-vinylpyridine) dispersed in the methanol solvent. FIG. 18 shows a Fast Fourier Transform (FFT) of the HR-TEM image and the density distribution of fringe spacings in a nano crystalline structure of the monomer film.

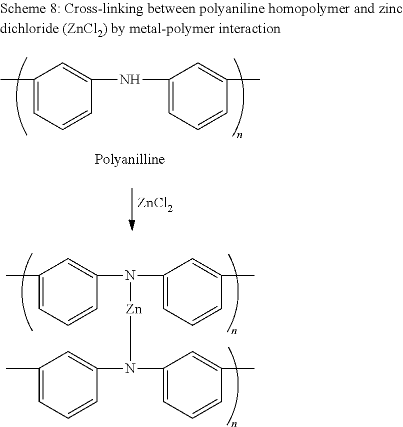

The same amount of ZnCl₂ as a nitrogen unit from polyaniline (an example of Formula 14a) was dissolved in a THF solvent and agitated in an atmosphere of nitrogen gas at a constant speed for 10 hours. Through the above procedure, the polymer-metal interaction between a halogenic group from the metal halide and nitrogen from the polymer was induced. After agitation, the mixture was coated on a silicon wafer. Here, to give crystallinity, the mixture coated on the silicon wafer was stored at room temperature for three days to slowly evaporate the solvent therefrom. The resulting film from which the solvent was slowly evaporated for three days was dried in an oven at 60° C. for 6 hours.

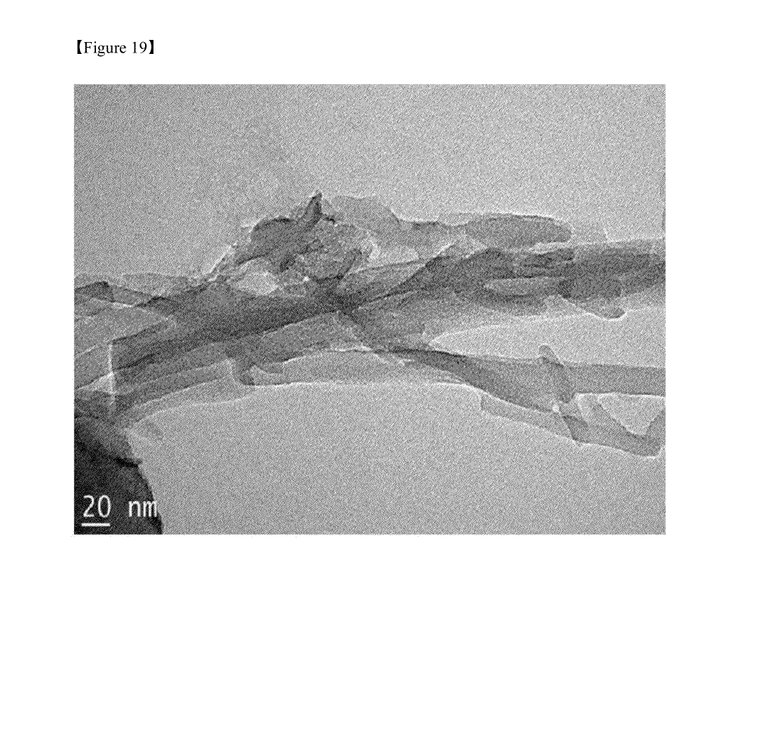

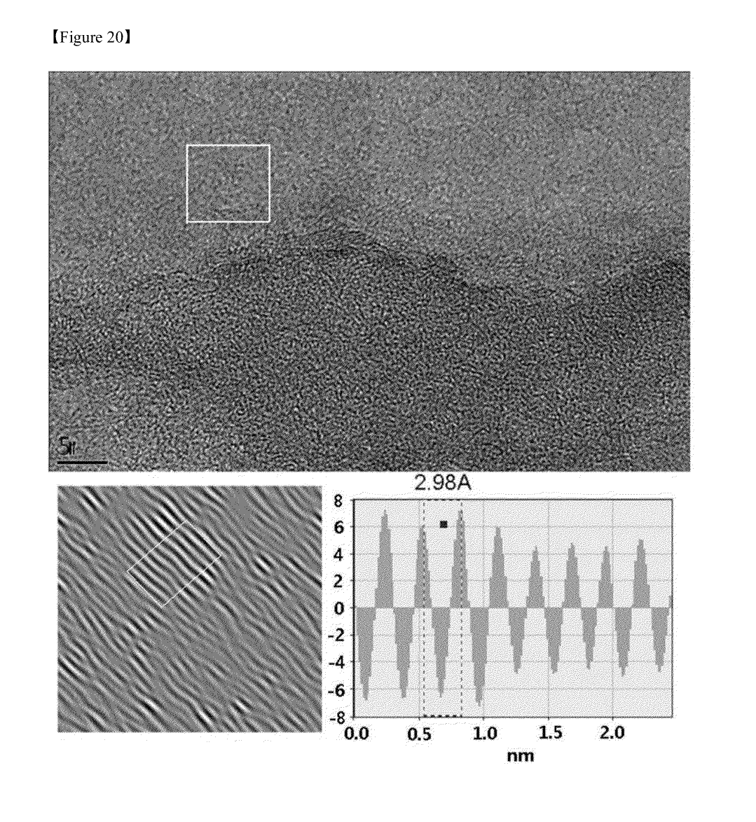

FIG. 19 shows an EF-TEM image of a rod-shaped polymer film cross-linked with ZnCl₂ by metal-polymer interaction in polyaniline. FIG. 20 shows an FFT of the HR-TEM image of the polymer film and a density distribution of fringe spacings in the nano crystalline structure.

### Example 3

### Formation of Organic Crystalline Structure Using Monomer

To nano-crystallize organic monomers of Formulae 12, 13, and 15, a monomer for an organic main material such as 2,2-bipyridine, and an intermediate for a linking material such as 1,4-dibromobutane, may be dissolved in a selective solvent in a molar ratio of 1:1, and then the mixture may be reacted at about 120° C. for about 48 hours. When the reaction terminated, the solvent may be removed, and uncoupled dibromobutane and bipyridine may be also removed. Here, the mixture may be coated on a silicon wafer and then the solvent may be slowly evaporated at room temperature for about three days. The resulting film from which the solvent is slowly evaporated for about three days may be dried in an oven at about 60° C. for about 6 hours.

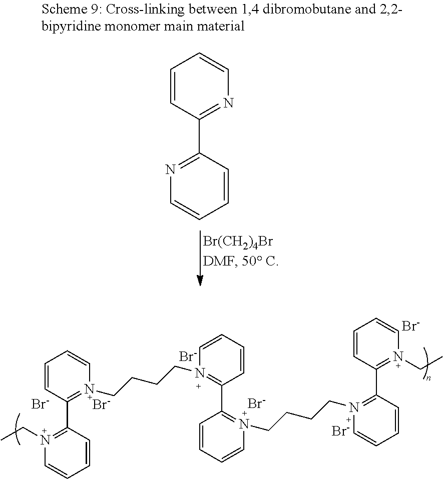

2,2-bipyridine of Formula 12c was mixed with 1,4-dibromobutane (an example of Formula 18b) in a DMF solvent in a molar ratio of 1:1, and the mixture was reacted at 120° C. for 48 hours. After the reaction finished, the DMF solvent was removed, and then uncoupled dibromobutane and bipyridine were removed by dialysis (membrane: Regenerated Cellulose MWCO:3500) in an atmosphere of MeOH for five days.

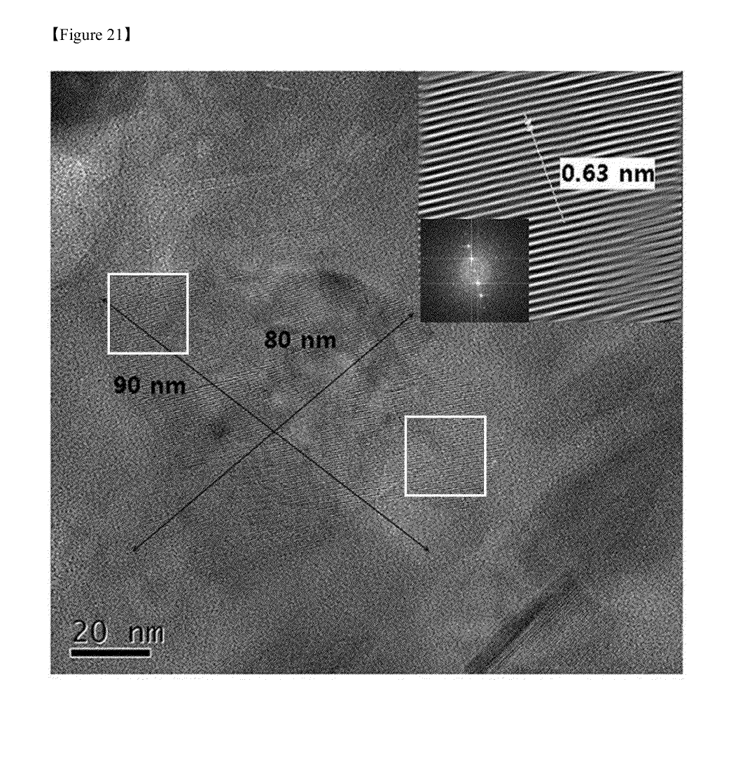

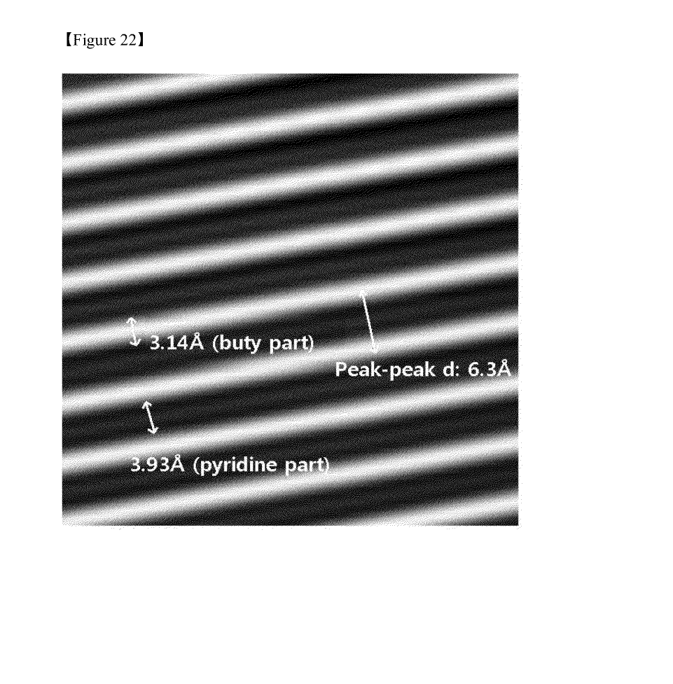

FIG. 21 shows an HR-TEM image, an FFT thereof and a diffraction result for a nano crystalline structure of a monomer film cross-linked with 1,4-dibromobutane in 2,2-bipyridine dispersed in the DMF solvent. FIG. 22 shows an FFT from the HR-TEM image and its enlarged image for the nano crystalline structure of the cross-linked monomer film.

### Example 4

### Cross-Linking Between 1,4-Dibromobutane as Linking Material and P2VP, PP2VP and PPP2VP Homopolymer as Main Material and Film Formed by Cross-Linking

P2VP, PP2VP and PPP2VP were mixed with 1,4-dibromodutane in THF solvents in a molar ratio of 1:1, and the mixtures were agitated at a constant speed for 10 hours. The agitation was performed in an atmosphere of nitrogen gas at room temperature to induce cross-linking between nitrogen from pyridine and bromine from 1,4-dibromobutane. After that, the mixture was coated on a silicon wafer. Here, in order to give crystallinity, the solution coated on the silicon wafer was stored at room temperature for three days to slowly evaporate the solvent therefrom. The resulting film from which the solvent was evaporated for three days was dried in an oven at 60° C. for 6 hours to yield a crystalline film.

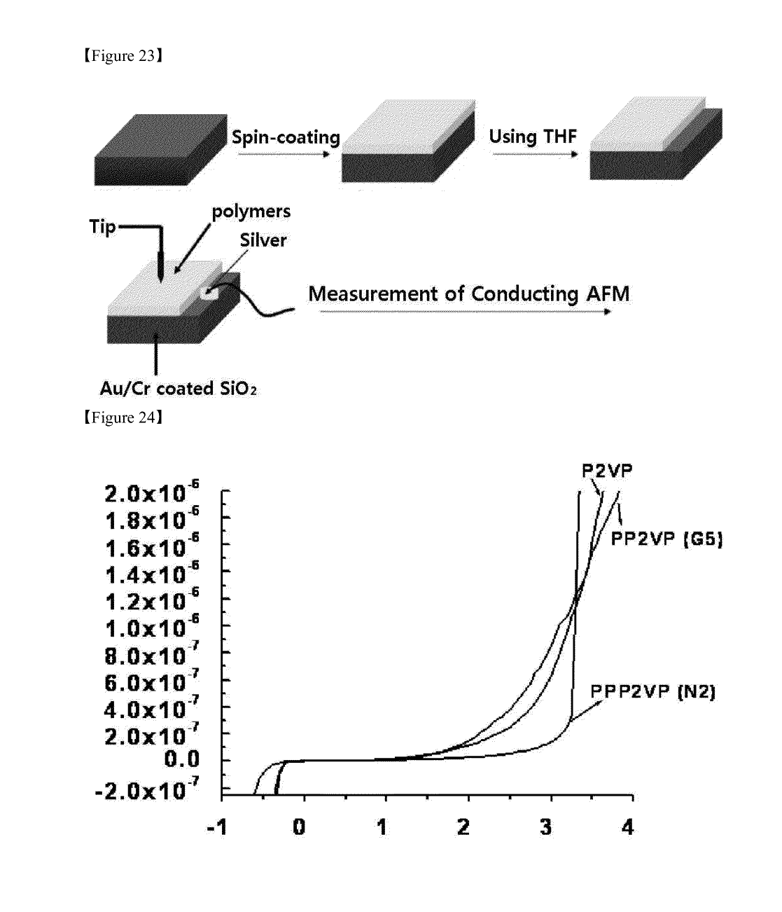

FIG. 23 shows a technique of measuring electrical characteristics of a polymer film having an organic crystalline structure formed according to the present embodiment. Referring to FIG. 23, first, a gold/chromium layer is formed on a silicon substrate by chemical vapor deposition (CVD). Subsequently, a polymer solution is dropped on a substrate having the gold/chromium layer, and spin coating is performed. After the spin coating, the polymer solution is cured at about 100° C. To introduce a silver electrode to a part of the polymer-coated substrate, one surface of the substrate is removed using tetrahydrofuran (THF), an organic solvent. Silver is introduced into the removed surface, and then electrical characteristics of organic single crystalline polymers having P2VP, PP2VP and PPP2VP as main material materials are estimated.

FIG. 24 is a graph showing electrical characteristics of organic single crystalline polymers according to a fourth exemplary embodiment of the present invention. Referring to FIG. 24, a thin film formed of an organic crystalline polymer has electrical characteristics of a diode. That is, at a voltage of about 2V, the current through a device is substantially 0, whereas at a voltage of 3.2V, the current through a device drastically increases. That is, the device maintains the “off” state at 2V or less, and maintains the “on” state at 3.2V or more. Particularly, PPP2VP having relatively a large amount of a phenyl group has excellent diode characteristics. As described above, the organic crystalline polymer according to the present embodiment exhibits excellent diode characteristics.

### Example 5

### Cross-Linking Between a Main Material Having π-Conjugated Back Bone and a Linking Material

The main material having π-conjugated back bone may be at least one of the compositions of Formulae 7 to 13, 14a, 15a, and 16a. In the case of Formulae 14a, 15a, and 16a, an unshared electron pair on nitrogen can participate π-conjugation. These main material having π-conjugated back bone may have conducting property showing various degrees. The main material can be a homopolymer such as Formulae 7, 10, 11, or 14a, a copolymer such as Formulae 8 or 9, or a monomer such as Formulae 12, 13, 15a, or 16a. Ar in Formulae 7, 10, and 11, at least one of Ar₁ and Ar₂ in each of Formulae 8, 12, 14a, 15a, and 16a and at least one of Ar₁, Ar₂, and Arₐ in each of Formulae 9 and 13 may be a substituted or unsubstituted C2 to C30 aryl group including at least one atom having an unshared electron pair, specifically a substituted or unsubstituted C2 to C30 heteroaryl group including at least one atom having an unshared electron pair as a ring member.

The linking material may be at least one of the compositions of Formula 17 or Formula 18, a homopolymer or a block copolymer including the repeating unit of Formula 19, or a metal salt of Formula 20.

The linking material may combine with the functional group in the adjacent main material by quaternization, hydrogen bonding, ionic bonding, or organic material-metal interaction. In this case, the main materials can be aligned to each other, thereby increasing conducting property. Also, π-π stacking can be achived between the aryl groups from the aligned and adjacent main materials, thereby further increasing conducting property.

Specifically, In case that the linking material is the composition of Formula 17, 18, or 19, and X, X₁ or X₂ in Formula 17, 18, or 19 is the halogen group, quaternization between the halogen group from the linking material and the atom having an unshared electron pair, for example, nitrogen from the main material can be achieved.

In case that the linking material is the composition of Formula 17, 18, or 19, and X, X₁ or X₂ in Formula 17, 18, or 19 is the functional group for hydrogen bonding such as a OH group, a SH group, a COOH group, or a NH₂ group, hydrogen bonding between the functional group from the linking material and the atom having an unshared electron pair, for example, oxygen from the main material can be achieved.

In case that the linking material is the composition of Formula 17, 18, or 19, and X, X₁ or X₂ in Formula 17, 18, or 19 is the acidic group such as a OH group, a COOH group, a SO₃H group, or a PO₄H₂ group, ionic bonding following protonization between the acidic group from the linking material and the atom having an unshared electron pair, for example, sulfur from the main material can be achieved.

In case that the linking material is a metal salt such as the compound of Formula 20, organic material-metal interaction between the metal ion from the linking material and the atom having an unshared electron pair from the main material can be achieved.

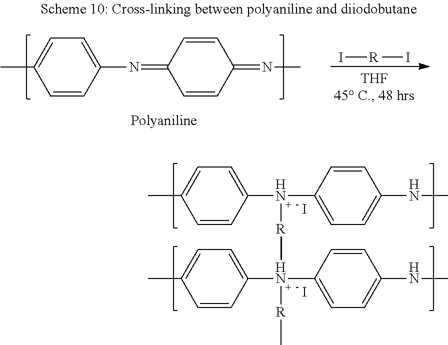

Polyaniline (emeraldine base type) as a main material (an example of Formula 16a) and 50 mol % diiodobutane as a linking material (an example of Formula 18) calculated based on the mole of nitrogen unit in polyaniline were added to a solvent of THF, and agitated at a constant speed at 45° C. for 48 hours by injecting nitrogen gas. Quaternization between iodine from the diiodobutane and nitrogen from the polyaniline was achieved. After agitation, the mixture was coated on a silicon oxide layer formed on a silicon wafer. To improve crystallinity, the resulting film was stored at room temperature for three days to slowly evaporate the solvent therefrom, and was dried in an oven at 60° C. for 6 hours. The dried film was dipped in 1N HCl aqueous solution for 1 hour to dope the film, the remaining acidic aqueous solution was removed by nitrogen gas, and then the film was dried in an oven at 60° C. for 1 hour.

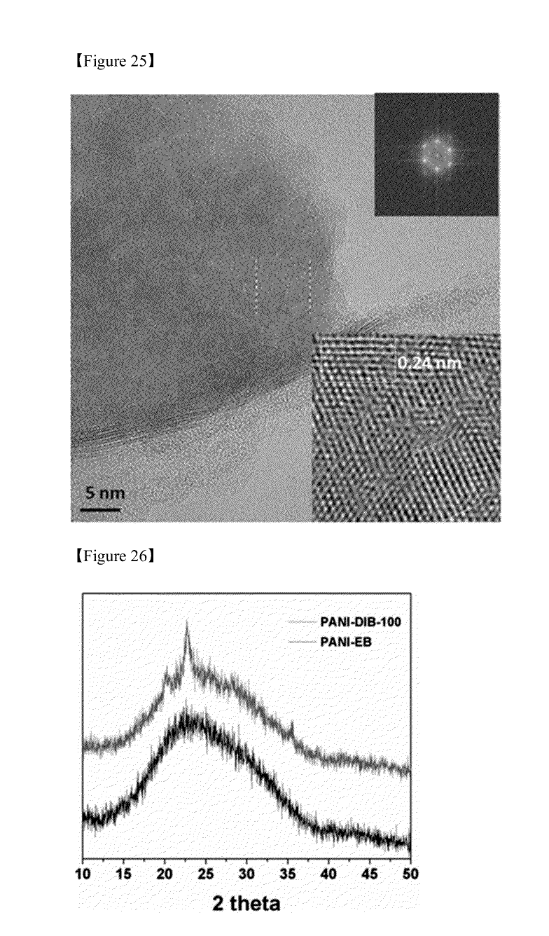

FIG. 25 shows a HR-TEM image and a Fourier transformed image of the film having cross-linked polyaniline and diiodobutane by quaternization. Referring to FIG. 25, the film is found to have an organic crystalline structure from the

TEM image, and the organic crystalline structure is found to have hexgonal structure from the Fourier transformed image. Also, it is found that the lattic constance of the organic crystalline structure is about 0.24 μm.

FIG. 26 shows an XRD result of the film having cross-linked polyaniline and diiodobutane by quaternization (PANI-DIB-100) and non cross-linked polyaniline (PANI-EB).

Referring to FIG. 26, the crystallinity of the cross-linked polyaniline by quaternization using diiodobutane (PANI-DIB-100, organic crystalline structure) is better than the crystallinity of the non cross-linked polyaniline (PANI-EB, emeraldine base type, amorphous). It is found that the linking length between the chains of polyaniline in the crystalline structure is uniformly formed in 0.34 nm.

TABLE 1

| | | Sheet | | |
|---|---|---|---|---|
| | Thickness | Resistance | Resistivity | Conductivity |
| | (nm) | (kΩ/sq) | (Ω · cm) | (S/cm) |
| PANI-ES-DIB | ~200 | 4.904 | 0.098 | 10.2 |
| PANI-ES | ~200 | 8.594 | 0.1718 | 5.6 |

Sheet resistance, resistivity, and conductivity are measured using 4-point probe method.

Referring to Table 1, the film (PANI-ES-DIB) having cross-linked polyaniline and diiodobutane by quaternization and doped has reduced sheet resistance and resistivity and increased conductivity (approximately two times) as compared to the film having non cross-linked polyaniline and doped. It is believed that the increase conductivity is because of the crystalline structure in the film (PANI-ES-DIB).

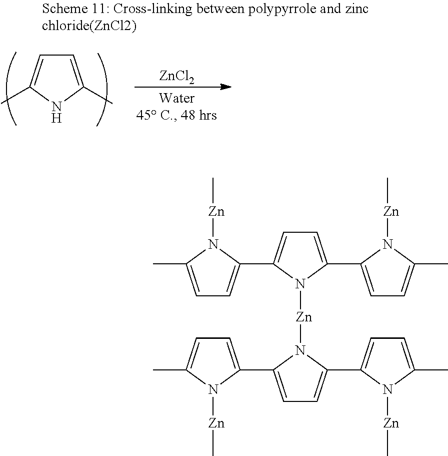

50 mol % ZnCl2 as a linking material (an example of Formula 20) calculated based on the mole of nitrogen unit in polypyrrole were added to a dispersion in which 5 wt. % polypyrrole as a main material (an example of Formula 7) is dispersed in water, and agitated at a constant speed at 45° C. for 48 hours by injecting nitrogen gas. Organic material-metal interaction between chlorine from ZnCl₂ and nitrogen from the polypyrrole was achieved. After agitation, the mixture was coated on a silicon oxide layer formed on a silicon wafer. To improve crystallinity, the resulting film was stored at room temperature for three days to slowly evaporate the solvent therefrom, and was dried in an oven at 60° C. for 6 hours.

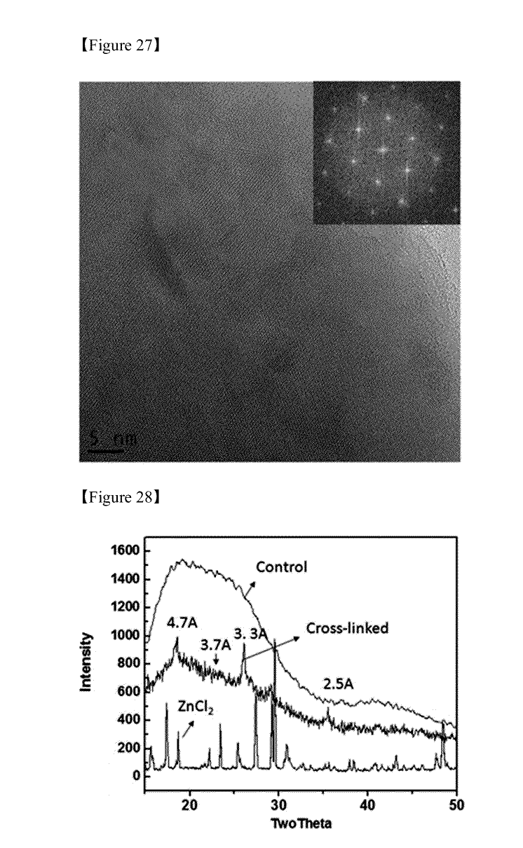

FIG. 27 shows a HR-TEM image and a Fourier transformed image of the film having crystallized polypyrrole and ZnCl₂ by organic material-metal interaction.

Referring to FIG. 27, the film is found to have an organic crystalline structure from the TEM image, and the organic crystalline structure is found to have hexgonal structure from the Fourier transformed image.

FIG. 28 shows an XRD result of the film having crystallized polypyrrole and ZnCl₂ by organic material-metal interaction.

Referring to FIG. 28, the crystallinity of the cross-linked polypyrrole by organic material-metal interaction using ZnCl₂ is better than the crystallinity of the non cross-linked polypyrrole itself (Control). It is found that the linking length between the chains of polypyrrole in the crystalline structure is uniformly formed in 0.33 nm.

TABLE 2

| | | Sheet | | |
|---|---|---|---|---|
| | Thickness | Resistance | Resistivity | Conductivity |
| | (nm) | (kΩ/sq) | (Ω · cm) | (S/cm) |
| PPy-Zn | ~190 | 4.545 | 0.0091 | ~11 |
| PPy | ~190 | 1053 | 20 | ~0.05 |

Sheet resistance, resistivity, and conductivity are measured using 4-point probe method.

Referring to Table 2, the film (PPy-Zn) having cross-linked polypyrrole and ZnCl2 by organic material-metal interaction has reduced sheet resistance and resistivity and increased conductivity (approximately 200 times) as compared to the film having non cross-linked polypyrrole(PPy). It is believed that the increase conductivity is because of the crystalline structure in the film (PPy-Zn).

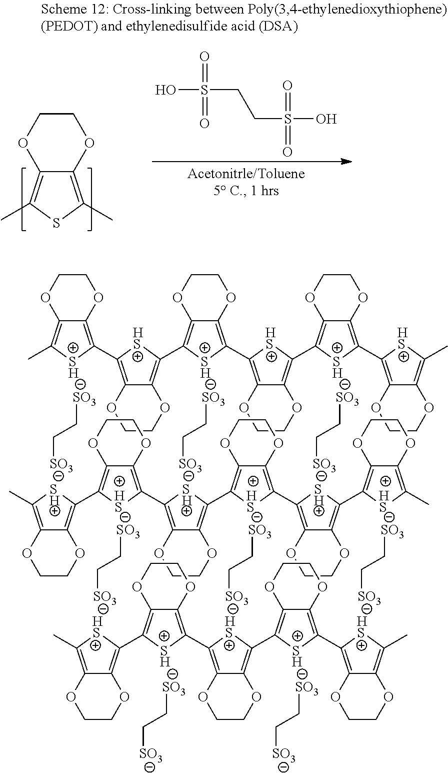

PEDOT as a main material (an example of Formula 7) and 50 mol % DSA as a linking material (an example of Formula 18) calculated based on the mole of sulfur unit in PEDOT were added to a solvent of Acetonitrile/Toluene(v/v=1), and agitated at a constant speed at 5° C. for 1 hour by injecting nitrogen gas. Protonation and ionic bonding was achieved between DSA and sulfur from the PEDOT. After agitation, the mixture was coated on a silicon oxide layer formed on a silicon wafer. To improve crystallinity, the resulting film was stored at room temperature for three days to slowly evaporate the solvent therefrom, and was dried in an oven at 60° C. for 6 hours.

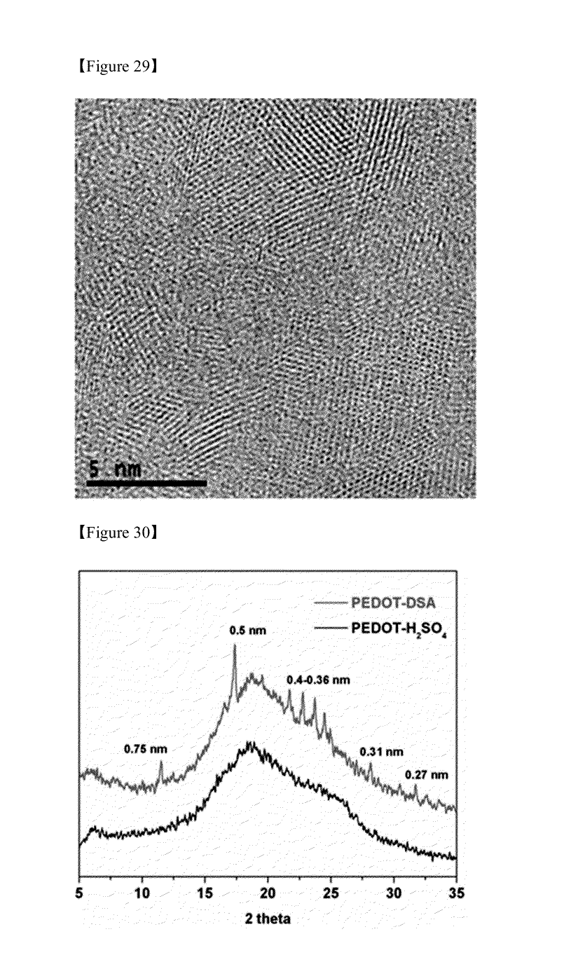

FIG. 29 shows a HR-TEM image of the film having cross-linked PEDOT and DSA by protonation and ionic bonding.

Referring to FIG. 29, the film is found to have an organic crystalline structure including lattice.

FIG. 30 shows an XRD result of the film having cross-linked PEDOT and DSA by protonation and ionic bonding.

Referring to FIG. 30, the crystallinity of the cross-linked PEDOT by protonation and ionic bonding using DSA (PEDOT-DSA) is better than the crystallinity of PEDOT mixed with H2SO4 (PEDOT-H2SO4). Here, it is shown that H2SO4 cannot act as a linker between the chains of PEDOT.

TABLE 3

| | | Sheet | | |
|---|---|---|---|---|
| | Thickness | Resistance | Resistivity | Conductivity |
| | (nm) | (kΩ/sq) | (Ω · cm) | (S/cm) |
| PEDOT-DSA | ~200 | 2.434 | 0.048 | 20.8 |
| PEDOT-H2SO4 | ~200 | 16.75 | 0.3584 | 2.79 |

Sheet resistance, resistivity, and conductivity are measured using 4-point probe method.

Referring to Table 3, the film (PEDOT-DSA) having cross-linked PEDOT and DSA by protonation and ionic bonding has reduced sheet resistance and resistivity and increased conductivity (approximately 10 times) as compared to the film having non cross-linked PEDOT (PEDOT-H2SO4). It is believed that the increase conductivity is because of the crystalline structure in the film (PEDOT-DSA).

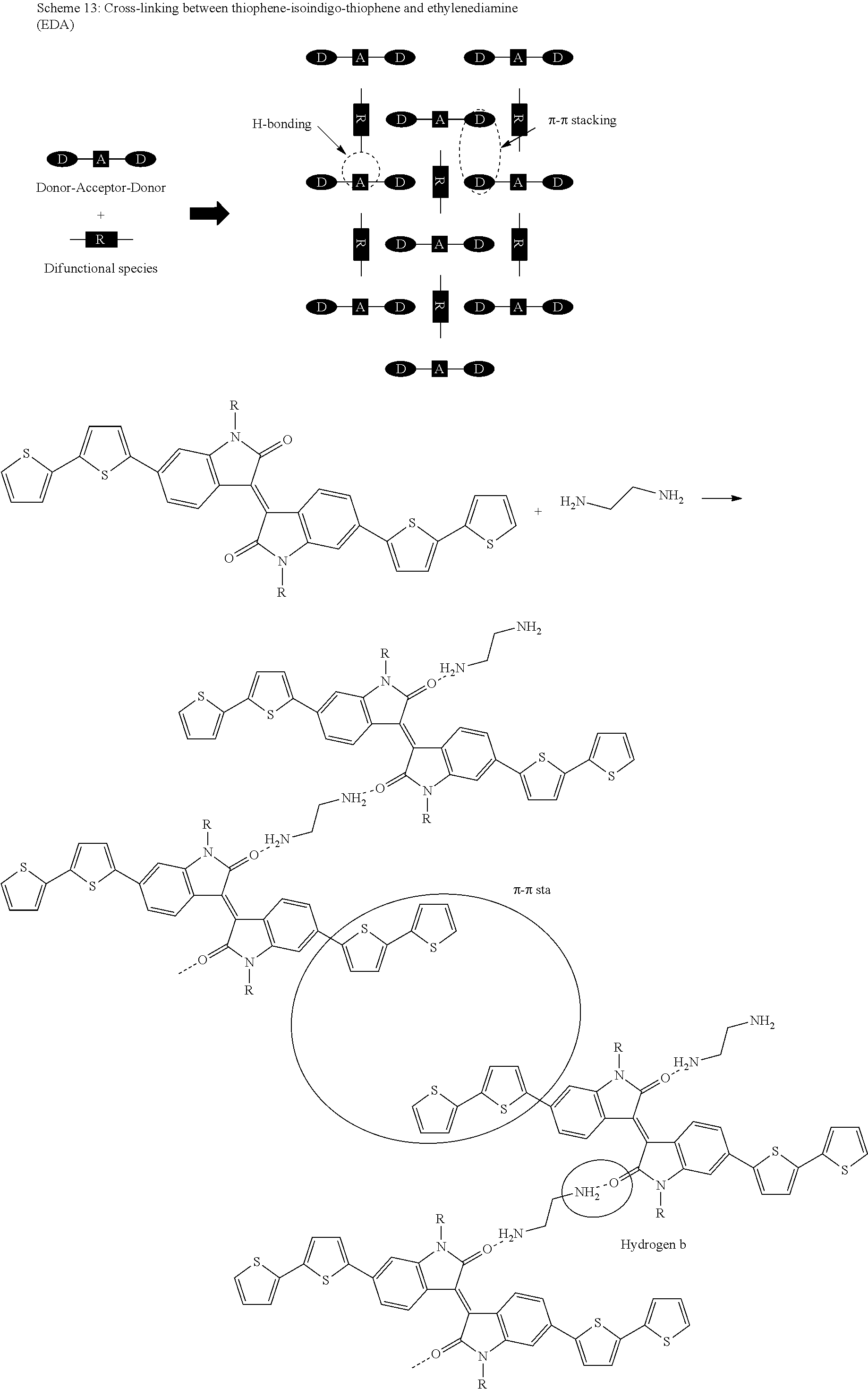

Thiophene-isoindigo-thiophene as a main material (Donor-Acceptor-Donor, an example of Formula 9a) and 100 mol % EDA as a linking material (an example of Formula 18) calculated based on the mole of isoindigo unit in the main material were added to a solvent of chloroform, and agitated at a constant speed at 45° C. for 24 hours by injecting nitrogen gas. Hydrogen bonding between H from EDA and oxygen from the isoindigo unit was achieved. After agitation, the mixture was coated on a silicon oxide layer formed on a silicon wafer. To improve crystallinity, the resulting film was stored at room temperature for three days to slowly evaporate the solvent therefrom, and was dried in an oven at 60° C. for 6 hours.

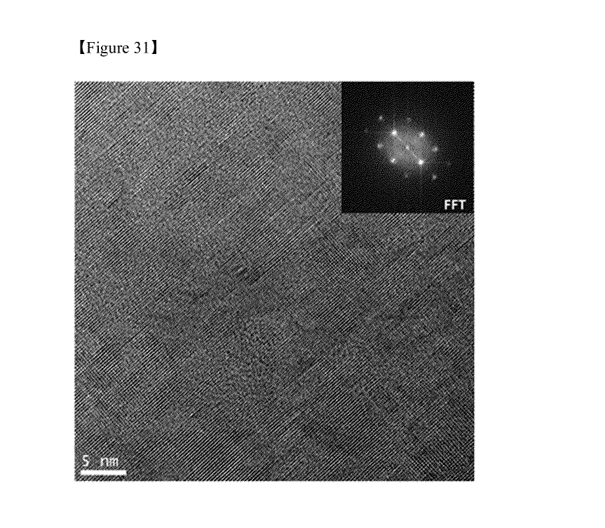

FIG. 31 shows a HR-TEM image and a Fourier transformed image of the film having cross-linked thiophene-isoindigo-thiophene and EDA by hydrogen bonding. Referring to FIG. 31, the film is found to have an organic crystalline structure including lattice from the TEM image, and the organic crystalline structure is found to have cubic structure from the Fourier transformed image.

TABLE 4

| | | Sheet | | |
|---|---|---|---|---|
| | Thickness | Resistance | Resistivity | Conductivity |
| | (nm) | (kΩ/sq) | (Ω · cm) | (S/cm) |
| thiophene- | ~100 | 1013 | 0.048 | 0.098 |
| isoindigo- | | | | |
| thiophene- | | | | |
| EDA | | | | |
| thiophene- | ~100 | 2787 | 0.3584 | 0.036 |
| isoindigo- | | | | |
| thiophene | | | | |

Sheet resistance, resistivity, and conductivity are measured using 4-point probe method.

Referring to Table 4, the film (thiophene-isoindigo-thiophene-EDA) having cross-linked thiophene-isoindigo-thiophene and EDA by hydrogen bonding has reduced sheet resistance and resistivity and increased conductivity (approximately 3 times) as compared to the film having non cross-linked thiophene-isoindigo-thiophene. It is believed that the increase conductivity is because of the crystalline structure in the film (thiophene-isoindigo-thiophene-EDA).

While the invention has been shown and described with reference to certain exemplary embodiments thereof, it will be understood by those skilled in the art that various changes in form and details may be made therein without departing from the spirit and scope of the invention as defined by the appended claims.

1. An organic crystalline composition, comprising:
a main material comprising a π-conjugated back bone and a functional group, wherein the functional group has an atom with an unshared electron pair; and
a linking material, wherein the linking material associates with the functional group of the main material by quaternization, organic material-metal interaction, ionic bonding, or hydrogen bonding.

2. The organic crystalline composition according to claim 1, wherein the atom having an unshared electron pair is selected from the group consisting of nitrogen(N), phosphorus(P), oxygen(O), sulfur(S), and selenium(Se).

3. The organic crystalline composition according to claim 2, wherein the functional group of the main material is selected from a group consisting of an amine, aniline, indolinone, carbazole, pyridine, pyrrole and thiophene.

4. The organic crystalline composition according to claim 2, wherein the functional group is selected from the group consisting of a pyridine, pyrazine, pyridazine, pyrimidine, triazine, tetrazine, oxazine, thiazine, selenazine, pyrrole, pyrazole, imidazole, dihydrothiazole, dihydrooxazole, dihydroselenazole, triazole, dihydrooxadiazole, dihydrothiadiazole, dihydroselenadiazole, thiophene, isothiazole, thiazole, dithiole, oxathiole, thiaselenaole, thiadiazole, oxathiazole, dithiazole and thiaselenazole.

5. The organic crystalline composition according to claim 1, wherein the main material has a composition of Formulae 7 to 13, 14a, 15a, or 16a: 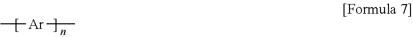
wherein
in Formula 7, Ar is a substituted or unsubstituted C2 to C30 aryl group comprising at least one atom having an unshared electron pair, and n is a number from 1 to 10,000,000, 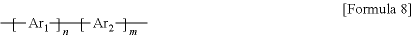
in Formula 8, at least one of Ar₁ and Ar₂ is a substituted or unsubstituted C2 to C30 aryl group having an unshared electron pair, the other of Ar₁ and Ar₂ is a substituted or unsubstituted C2 to C30 aryl group, n is a number from 1 to 10,000,000, and m is a number from 1 to 10,000,000, 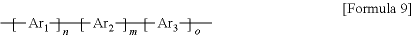
in Formula 9, at least one of Ar₁, Ar₂, and Ar₃ is a substituted or unsubstituted C2 to C30 aryl group having an unshared electron pair, the other(s) of Ar₁, Ar₂, and Ar₃ is a substituted or unsubstituted C2 to C30 aryl group, n is a number from 1 to 10,000,000, m is a number from 1 to 10,000,000, and o is a number from 1 to 10,000,000, 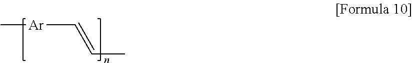
in Formula 10, Ar is a substituted or unsubstituted C2 to C30 aryl group including at least one atom having an unshared electron pair, and n is a number from 1 to 10,000,000, 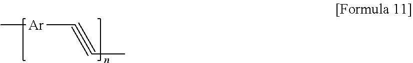
in Formula 11, Ar is a substituted or unsubstituted C2 to C30 aryl group including at least one atom having an unshared electron pair, and n is a number from 1 to 10,000,000,
Ar₁—Ar₂ [Formula 12]
in Formula 12, at least one of Ar₁ and Ar₂ is a substituted or unsubstituted C2 to C30 aryl group having an unshared electron pair, and the other of Ar₁ and Ar₂ is a substituted or unsubstituted C2 to C30 aryl group.
Ar₁—Ar₂—Ar₃ [Formula 13]
in Formula 13, at least one of Ar₁, Ar₂, and Ar₃ is a substituted or unsubstituted C2 to C30 aryl group having an unshared electron pair, and the other(s) of Ar₁, Ar₂, and Ar₃, are a substituted or unsubstituted C2 to C30 aryl group, 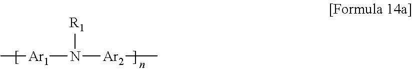
in Formula 14a, Ar₁ and Ar₂ is each independently a substituted or unsubstituted C2 to C30 aryl group, and R₁ is a bond to the Ar₂, a hydrogen group, a substituted or unsubstituted C1 to C12 alkyl group, or a substituted or unsubstituted C2 to C30 aryl group, and n is a number from 2 to 10,000,000, 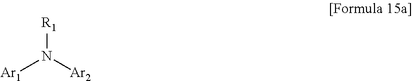
in Formula 15a, Ar₁ and Ar₂ is each independently a substituted or unsubstituted C2 to C30 aryl group, and R₁ is a bond to the Ar₂, a hydrogen group, a substituted or unsubstituted C1 to C12 alkyl group, or a substituted or unsubstituted C2 to C30 aryl group, 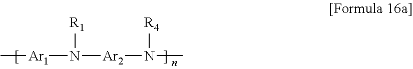
in Formula 16a, Ar₁ and Ar₂ are each independently a substituted or unsubstituted C2 to C30 aryl group, R₁ and R₄ are each independently a bond to the Ar₂, a hydrogen group, a substituted or unsubstituted C1 to C12 alkyl group, or a substituted or unsubstituted C2 to C30 aryl group, and n is a number from 2 to 10,000,000.

6. The organic crystalline composition according to claim 5, wherein
the main material represented by Formula 8 is a composition of Formula 8a: 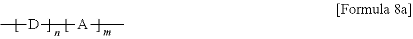
wherein in Formula 8a, D is an electron donor material, A is an electron acceptor material, and n and m are defined as for Formula 8, or
the main material represented by Formula 9 is a composition of Formulae 9a or 9b: 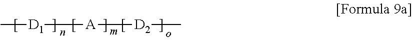
wherein in Formula 9a, D₁ and D₂ are the same or different electron donor materials, A is an electron acceptor material, and n, m, and o are defined as for Formula 9, and 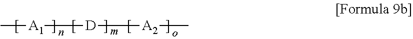
in Formula 9b, D is an electron donor material, A₁ and A₂ are the same or different electron acceptor materials, and n, m, and o are defined as for Formula 9, or
the main material represented by Formula 12 is a composition of Formulae 12a, 12b, or 12c:
D-A [Formula 12a]
wherein in Formula 12a, D is an electron donor material, and A is an electron acceptor material, 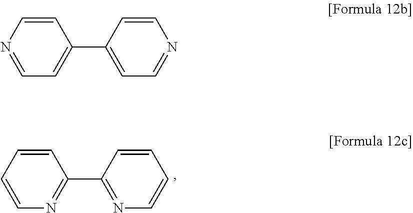 [SMILES: c1cc(-c2ccncc2)ccn1 ; c1ccc(-c2ccccn2)nc1]
or
the main material represented by Formula 13 is a composition of Formulae 13a or 13b:
D₁-A-D₂ [Formula 13a]
wherein in Formula 13a, D₁ and D₂ are the same or different electron donor materials, and A is an electron acceptor material, and
A₁-D-A₂ [Formula 13b]
in Formula 13b, D is an electron donor material, and A₁ and A₂ are the same or different electron acceptor materials.

7. The organic crystalline composition according to claim 6, wherein each of the electron donor materials is a substituted or unsubstituted thiophene group, or a substituted or unsubstituted carbazole group, and
each of the electron acceptor materials is a substituted or unsubstituted thienopyrroledione group, a substituted or unsubstituted diketopyrrolopyrrole group, a substituted or unsubstituted indolinone group, or a substituted or unsubstituted isoindigo group.

8. The organic crystalline composition according to claim 1, wherein the linking material is a composition of Formula 18, or a metal salt of Formula 20:
X₁—Y—X₂ [Formula 18]
wherein in Formula 18, Y is a substituted or unsubstituted C1 to C8 alkyl group, or a substituted or unsubstituted C2 to C30 aryl group, a substituted or unsubstituted polyaryl group having 2 to 8 repeating C2 to C30 aryl groups, or a substituted or unsubstituted ferrocene group, and
X₁, and X₂ are each independently a halogen group, an acidic functional group, or a functional group for hydrogen bonding, and
MLn [Formula 20]
in Formula 20, M is a metal, L is a ligand, and n is a number of 1 to 8.

9. The organic crystalline composition according to claim 8, wherein the halogen group is a Cl group, a Br group, or an I group, the acidic functional group is a OH group, a COOH group, a SO₃H group, or a PO₄H₂ group, and the functional group for hydrogen bonding is a OH group, a SH group, a COOH group, or a NH₂ group.

10. The organic crystalline composition according to claim 8, wherein the linking material represented by Formula 18 is one of the compositions of Formulae 18a, 18b, 18c, or 18d: 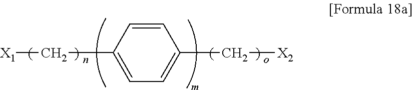
wherein in Formula 18a, X₁, and X₂ are defined as for Formula 18, and n, m, and o is each independently 0 to 8, provided that the sum of n, m, and o is the number of 1 to 8, and 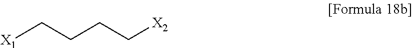
in Formula 18b, X₁, and X₂ are defined as for Formula 18, and 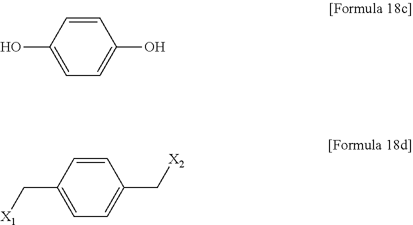
in Formula 18d, X₁ and X₂ are defined as for Formula 18.

11. The organic crystalline composition according to claim 8, wherein the linking material is the composition of Formula 18, X₁ and X₂ in Formula 18 are halogen groups, and quaternization is achieved between each of the halogen groups from the linking material and the atom having an unshared electron pair from the main material.

12. The organic crystalline composition according to claim 8, wherein the linking material is the composition of Formula 18, X₁ and X₂ in Formula 18 are the functional groups for hydrogen bonding, and hydrogen bonding is achieved between each of the functional groups from the linking material and the atom having an unshared electron pair from the main material.

13. The organic crystalline composition according to claim 8, wherein the linking material is the composition of Formula 18, X₁ and X₂ in Formula 18 are the acidic groups, and ionic bonding following protonization is achieved between each of the acidic groups from the linking material and the atom having an unshared electron pair from the main material.

14. The organic crystalline composition according to claim 8, wherein the linking material is a metal salt of Formula 20, and organic material-metal interaction is achieved between the metal ion from the linking material and the atom having an unshared electron pair from the main material.
